(19) United States
(12) Patent Application Publication
(10) Pub. No.: US 2023/0000074 A1
(43) Pub. Date: Jan. 5, 2023

(54) SPRAYABLE MICROENCAPSULATED PHEROMONES

(71) Applicant: Provivi, Inc., Santa Monica, CA (US)

(72) Inventors: Chanjoong Kim, Diamond Bar, CA (US); Jan Bello, Santa Monica, CA (US); Renjie Zhou, Santa Monica, CA (US)

(21) Appl. No.: 17/678,966

(22) Filed: Feb. 23, 2022

Related U.S. Application Data
(60) Provisional application No. 63/280,088, filed on Nov. 16, 2021.
(60) Provisional application No. 63/152,714, filed on Feb. 23, 2021.

(51) Int. Cl. A01N 25/04; A01N 25/28; A01N 25/30; A01N 31/02; A01N 27/00; C08G 18/10; C08G 18/32; B01J 13/16; A01P 19/00

(52) U.S. Cl. CPC A01N 25/04; A01N 25/28; A01N 25/30; A01N 31/02; A01N 27/00; C08G 18/10; C08G 18/3228; B01J 13/16; A01P 19/00

(57) ABSTRACT

This disclosure provides agrochemical compositions and methods of manufacturing and using the same. In embodiments, the present disclosure relates to agrochemical compositions comprising one or more pheromones.

### CROSS-REFERENCE TO RELATED APPLICATIONS

This application claims the benefit of the filing date of U.S. Provisional Patent Application Ser. No. 63/152,714, filed Feb. 23, 2021 for “SPRAYABLE MICROENCAPSULATED PHEROMONES” and U.S. Provisional Patent Application Ser. No. 63/280,088, filed Nov. 16, 2021 for “SPRAYABLE MICROENCAPSULATED PHEROMONES” which are incorporated herein in its entirety.

### TECHNICAL FIELD

The disclosure provides for agricultural compositions comprising active ingredients such as pheromones. In embodiments, the disclosure teaches sprayable microencapsulated compositions that release active ingredients in a controlled manner. The compositions may be formulated in a myriad of delivery forms that include, inter alia, granules, flakes, strings, and dispensers.

### BACKGROUND

The world's population is dramatically increasing and concomitant with that rise in population is an urgent need to meet the burgeoning population's food demands. Traditionally, modern agriculture has relied upon chemistry to help control pest populations and ensure steady and predictable food yields. However, there is an increasing recognition that agricultural chemicals may have a detrimental effect upon the environment. Thus, there is an urgent demand for a more sustainable way to meet the world's food requirements and ultimately transition chemistry-based row crop agriculture to a more sustainable and environmentally friendly paradigm.

### DISCLOSURE

This invention describes the composition of and method to produce pheromone capsule suspension (CS) formulations that slowly release pheromone after being sprayed. The CS formulation is comprising of (i) at least one active ingredient of sex pheromone, (ii) at least one polyurea shell material, and (iii) appropriate additives. The method to produce the formulation involves emulsification of oily components in an aqueous phase at either ambient or elevated temperatures followed by formation of polyurea (“PUR”) shell formation on the surface of emulsion droplets.

In a particular embodiment, the two major formulation components are a pheromone and a microcapsule material. The pheromone can be (Z)-7-dodecenyl Acetate (Z7-12Ac), or a mixture of (Z)-9-Tetradecenyl Acetate (Z9-14Ac) and (Z)-11-Hexadecenyl Acetate (Z11-16Ac) (e.g., in a mass ratio of 87:13), referred to as FAW blend, or a mixture of (Z)-11-Hexadecenal (Z11-16Ald) and (Z)-11-Hexadecenyl Acetate (Z11-16Ac) (e.g., in a mass ratio of 50:50). The microcapsule material in the examples is polyurea that is formed by interfacial polymerization between diisocyanates and multiamines. At least one surfactant may also be included. The minor components are additives such as suspending agent, viscosity modifier, anti-freezer, and biocides. The median diameters of microcapsules are in the range of 3-20 microns. The performance of PUR microcapsules is evaluated in an oven at particular conditions and shows slow-release kinetics longer than 14 days.

Another aspect of the invention describes a preparation of melamine-urea-formaldehyde (“MUF”) microencapsulated pheromones as an alternative to polyurea microencapsulated pheromones in sprayable active ingredient (“AI”) formulations. The invention also describes the use of Sodium lignosulfonate as the emulsifier in the preparation of melamine-urea-formaldehyde (MUF) microcapsules used in sprayable formulations. For the various embodiments of the invention, the degree of sulfonation of lignosulfonates of claim 17 is in the range of 0.5-3.3 moles/kg. Previously used preparations utilize styrene-maleic anhydride (SMA) as the emulsifier during MUF in situ polymerization, unfortunately the use of SMA as the emulsifier resulted in capsule coalescence, inconsistent capsule size and stability, and variations in performance. The variability in the microcapsule size and performance from the SMA emulsifier microcapsules hinders the scalability of the MUF microcapsule formulations and makes the production of MUF microcapsules consistent in size and performance very difficult. By using lignosulfonate as the emulsifier in the in situ polymerization reaction, microcapsule coalescence is minimized, and the resulting microcapsules are consistent in size, making scalability much more feasible.

Yet another aspect of the invention describes the composition and the process for preparing hybrid polyurea/melamine-urea-formaldehyde (“PUR/MUF”) based microencapsulated sprayable pheromone formulations. These PUR/MUF hybrid microcapsule formulations should slowly release the encapsulated pheromone after spraying. The PUR/MUF hybrid capsules are comprised of an oil-based core comprised of AI and additives and a double layer shell made of a polyurea layer and melamine-urea-formaldehyde (MUF) layer. The polyurea shell is formed via interfacial polycondensation of multiamines and diisocyantes and is then further encapsulated by a MUF exterior shell via a two-step in situ polymerization. The resulting capsule is highly stable and encapsulates the AI oil layer very efficiently (>97% encapsulation efficiency).

Sprayable formulations of the various embodiments of the described inventions can include, but are not limited to, formulations having:
Active ingredient content: 1-50 wt %;
Antioxidant: 0.01-5 wt %; and
microcapsule shell materials: 2-10 wt %;
wherein the median microcapsule diameter is 1-100 microns.

Sprayable formulations of the various embodiments of the inventions include any suitable insect pheromone, including, but not limited to: (E)-2-Decen-1-ol; (E,E)-10,12-Tetradecadien-1-ol; (E)-2-Decenyl acetate; (E,E)-10,12-Tetradecadienyl acetate; (E)-2-Decenal; (E,E)-10,12-Tetradecadienal; (Z)-2-Decen-1-ol; (E,Z)-10,12-Tetradecadienyl acetate; (Z)-2-Decenyl acetate; (Z,E)-10,12-Tetradecadienyl acetate; (Z)-2-Decenal; (Z,Z)-10,12-Tetradecadien-1-ol; (E)-3-Decen-1-ol; (Z,Z)-10,12-Tetradecadienyl acetate; (Z)-3-Decenyl acetate; (E,Z,Z)-3,8,11-Tetradecatrienyl acetate; (Z)-3-Decen-1-ol; (E)-8-Pentadecen-1-ol; (Z)-4-Decen-1-ol (E)-8-Pentadecenyl acetate; (E)-4-Decenyl acetate; (Z)-8-Pentadecen-1-ol; (Z)-4-Decenyl acetate; (Z)-8-Pentadecenyl acetate; (Z)-4-Decenal; (Z)-9-Pentadecenyl acetate; (E)-5-Decen-1-ol; (E)-9-Pentadecenyl acetate; (E)-5-Decenyl acetate; (Z)-10-Pentadecenyl acetate; (Z)-5-Decen-1-ol; (Z)-10-Pentadecenal; (Z)-5-Decenyl acetate; (E)-12-Pentadecenyl acetate; (Z)-5-Decenal; (Z)-12-Pentadecenyl acetate; (E)-7-Decenyl acetate; (Z,Z)-6,9-Pentadecadien-1-ol; (Z)-7-Decenyl acetate; (Z,Z)-6,9-Pentadecadienyl acetate; (E)-8-Decen-1-ol; (Z,Z)-6,9-Pentadecadienal; (E,E)-2,4-Decadienal; (E,E)-8,10-Pentadecadienyl acetate; (E,Z)-2,4-Decadienal; (E,Z)-8,10-Pentadecadien-1-ol; (Z,Z)-2,4-Decadienal; (E,Z)-8,10-Pentadecadienyl acetate; (E,E)-3,5-Decadienyl acetate; (Z,E)-8,10-Pentadecadienyl acetate; (Z,E)-3,5-Decadienyl acetate; (Z,Z)-8,10-Pentadecadienyl acetate; (Z,Z)-4,7-Decadien-1-ol; (E,Z)-9,11-Pentadecadienal; (Z,Z)-4,7-Decadienyl acetate; (Z,Z)-9,11-Pentadecadienal; (E)-2-Undecenyl acetate; (Z)-3-Hexadecenyl acetate; (E)-2-Undecenal; (E)-5-Hexadecen-1-ol; (Z)-5-Undecenyl acetate; (E)-5-Hexadecenyl acetate; (Z)-7-Undecenyl acetate; (Z)-5-Hexadecen-1-ol (Z)-8-Undecenyl acetate; (Z)-5-Hexadecenyl acetate; (Z)-9-Undecenyl acetate; (E)-6-Hexadecenyl acetate; (E)-2-Dodecenal; (E)-7-Hexadecen-1-ol; (Z)-3-Dodecen-1-ol; (E)-7-Hexadecenyl acetate; (E)-3-Dodecenyl acetate; (E)-7-Hexadecenal; (Z)-3-Dodecenyl acetate; (Z)-7-Hexadecen-1-ol; (E)-4-Dodecenyl acetate; (Z)-7-Hexadecenyl acetate; (E)-5-Dodecen-1-ol; (Z)-7-Hexadecenal; (E)-5-Dodecenyl acetate; (E)-8-Hexadecenyl acetate; (Z)-5-Dodecen-1-ol; (E)-9-Hexadecen-1-ol; (Z)-5-Dodecenyl acetate; (E)-9-Hexadecenyl acetate; (Z)-5-Dodecenal; (E)-9-Hexadecenal; (E)-6-Dodecen-1-ol; (Z)-9-Hexadecen-1-ol; (Z)-6-Dodecenyl acetate; (Z)-9-Hexadecenyl acetate; (E)-6-Dodecenal; (Z)-9-Hexadecenal; (E)-7-Dodecen-1-ol; (E)-10-Hexadecen-1-ol; (E)-7-Dodecenyl acetate; (E)-10-Hexadecenal; (E)-7-Dodecenal; (Z)-10-Hexadecenyl acetate; (Z)-7-Dodecen-1-ol; (Z)-10-Hexadecenal; (Z)-7-Dodecenyl acetate; (E)-11-Hexadecen-1-ol; (Z)-7-Dodecenal; (E)-11-Hexadecenyl acetate; (E)-8-Dodecen-1-ol; (E)-11-Hexadecenal; (E)-8-Dodecenyl acetate; (Z)-11-Hexadecen-1-ol; (E)-8-Dodecenal; (Z)-11-Hexadecenyl acetate; (Z)-8-Dodecen-1-ol; (Z)-11-Hexadecenal; (Z)-8-Dodecenyl acetate; (Z)-12-Hexadecenyl acetate; (E)-9-Dodecen-1-ol; (Z)-12-Hexadecenal; (E)-9-Dodecenyl acetate; (E)-14-Hexadecenal; (E)-9-Dodecenal; (Z)-14-Hexadecenyl acetate; (Z)-9-Dodecen-1-ol; (E,E)-1,3-Hexadecadien-1-ol; (Z)-9-Dodecenyl acetate; (E,Z)-4,6-Hexadecadien-1-ol; (Z)-9-Dodecenal (E,Z)-4,6-Hexadecadienyl acetate; (E)-10-Dodecen-1-ol; (E,Z)-4,6-Hexadecadienal; (E)-10-Dodecenyl acetate; (E,Z)-6,11-Hexadecadienyl acetate; (E)-10-Dodecenal; (E,Z)-6,11-Hexadecadienal; (Z)-10-Dodecen-1-ol; (Z,Z)-7,10-Hexadecadien-1-ol; (Z)-10-Dodecenyl acetate; (Z,Z)-7,10-Hexadecadienyl acetate; (E,Z)-3,5-Dodecadienyl acetate; (Z,E)-7,11-Hexadecadien-1-ol; (Z,E)-3,5-Dodecadienyl acetate; (Z,E)-7,11-Hexadecadienyl acetate; (Z,Z)-3,6-Dodecadien-1-ol; (Z,E)-7,11-Hexadecadienal; (E,E)-4,10-Dodecadienyl acetate; (Z,Z)-7,11-Hexadecadien-1-ol; (E,E)-5,7-Dodecadien-1-ol; (Z,Z)-7,11-Hexadecadienyl acetate; (E,E)-5,7-Dodecadienyl acetate; (Z,Z)-7,11-Hexadecadienal; (E,Z)-5,7-Dodecadien-1-ol; (Z,Z)-8,10-Hexadecadienyl acetate; (E,Z)-5,7-Dodecadienyl acetate; (E,Z)-8,11-Hexadecadienal; (E,Z)-5,7-Dodecadienal; (E,E)-9,11-Hexadecadienal; (Z,E)-5,7-Dodecadien-1-ol; (E,Z)-9,11-Hexadecadienyl acetate; (Z,E)-5,7-Dodecadienyl acetate; (E,Z)-9,11-Hexadecadienal; (Z,E)-5,7-Dodecadienal; (Z,E)-9,11-Hexadecadienal; (Z,Z)-5,7-Dodecadienyl acetate; (Z,Z)-9,11-Hexadecadienal; (Z,Z)-5,7-Dodecadienal; (E,E)-10,12-Hexadecadien-1-ol; (E,E)-7,9-Dodecadienyl acetate; (E,E)-10,12-Hexadecadienyl acetate; (E,Z)-7,9-Dodecadien-1-ol; (E,E)-10,12-Hexadecadienal; (E,Z)-7,9-Dodecadienyl acetate; (E,Z)-10,12-Hexadecadien-1-ol; (E,Z)-7,9-Dodecadienal; (E,Z)-10,12-Hexadecadienyl acetate; (Z,E)-7,9-Dodecadien-1-ol; (E,Z)-10,12-Hexadecadienal; (Z,E)-7,9-Dodecadienyl acetate; (Z,E)-10,12-Hexadecadienyl acetate; (Z,Z)-7,9-Dodecadien-1-ol; (Z,E)-10,12-Hexadecadienal; (Z,Z)-7,9-Dodecadienyl acetate; (Z,Z)-10,12-Hexadecadienal; (E,E)-8,10-Dodecadien-1-01; (E,E)-11,13-Hexadecadien-1-ol; (E,E)-8,10-Dodecadienyl acetate; (E,E)-11,13-Hexadecadienyl acetate; (E,E)-8,10-Dodecadienal; (E,E)-11,13-Hexadecadienal; (E,Z)-8,10-Dodecadien-1-ol; (E,Z)-11,13-Hexadecadien-1-ol; (E,Z)-8,10-Dodecadienyl acetate; (E,Z)-11,13-Hexadecadienyl acetate; (E,Z)-8,10-Dodecadienal; (E,Z)-11,13-Hexadecadienal; (Z,E)-8,10-Dodecadien-1-ol; (Z,E)-11,13-Hexadecadien-1-ol; (Z,E)-8,10-Dodecadienyl acetate; (Z,E)-11,13-Hexadecadienyl acetate; (Z,E)-8,10-Dodecadienal; (Z,E)-11,13-Hexadecadienal; (Z,Z)-8,10-Dodecadien-1-ol; (Z,Z)-11,13-Hexadecadien-1-ol; (Z,Z)-8,10-Dodecadienyl acetate; (Z,Z)-11,13-Hexadecadienyl acetate; (Z,E,E)-3,6,8-Dodecatrien-1-ol; (Z,Z)-11,13-Hexadecadienal; (Z,Z,E)-3,6,8-Dodecatrien-1-ol; (E,E)-10,14-Hexadecadienal; (E)-2-Tridecenyl acetate; (Z,E)-11,14-Hexadecadienyl acetate; (Z)-2-Tridecenyl acetate; (E,E,Z)-4,6,10-Hexadecatrien-1-ol; (E)-3-Tridecenyl acetate; (E,E,Z)-4,6,10-Hexadecatrienyl acetate; (E)-4-Tridecenyl acetate; (E,Z,Z)-4,6,10-Hexadecatrien-1-ol; (Z)-4-Tridecenyl acetate; (E,Z,Z)-4,6,10-Hexadecatrienyl acetate; (Z)-4-Tridecenal (E,E,Z)-4,6,11-Hexadecatrienyl acetate; (E)-6-Tridecenyl acetate (E,E,Z)-4,6,11-Hexadecatrienal (Z)-7-Tridecenyl acetate (Z,Z,E)-7,11,13-Hexadecatrienal (E)-8-Tridecenyl acetate; (E,E,E)-10,12,14-Hexadecatrienyl acetate; (Z)-8-Tridecenyl acetate; (E,E,E)-10,12,14-Hexadecatrienal; (E)-9-Tridecenyl acetate; (E,E,Z)-10,12,14-Hexadecatrienyl acetate; (Z)-9-Tridecenyl acetate; (E,E,Z)-10,12,14-Hexadecatrienal; (Z)-10-Tridecenyl acetate; (E,E,Z,Z)-4,6,11,13-Hexadecatetraenal; (E)-11-Tridecenyl acetate; (E)-2-Heptadecenal; (Z)-11-Tridecenyl acetate; (Z)-2-Heptadecenal; (E,Z)-4,7-Tridecadienyl acetate; (E)-8-Heptadecen-1-ol; (Z,Z)-4,7-Tridecadien-1-ol; (E)-8-Heptadecenyl acetate; (Z,Z)-4,7-Tridecadienyl acetate; (Z)-8-Heptadecen-1-ol; (E,Z)-5,9-Tridecadienyl acetate; (Z)-9-Heptadecenal; (Z,E)-5,9-Tridecadienyl acetate; (E)-10-Heptadecenyl acetate; (Z,Z)-5,9-Tridecadienyl acetate; (Z)-11-Heptadecen-1-ol; (Z,Z)-7,11-Tridecadienyl acetate; (Z)-11-Heptadecenyl acetate; (E,Z,Z)-4,7,10-Tridecatrienyl acetate; (E,E)-4,8-Heptadecadienyl acetate; (E)-3-Tetradecen-1-ol; (Z,Z)-8,10-Heptadecadien-1-ol; (E)-3-Tetradecenyl acetate; (Z,Z)-8,11-Heptadecadienyl acetate; (Z)-3-Tetradecen-1-ol; (E)-2-Octadecenyl acetate; (Z)-3-Tetradecenyl acetate; (E)-2-Octadecenal; (E)-5-Tetradecen-1-ol; (Z)-2-Octadecenyl acetate; (E)-5-Tetradecenyl acetate; (Z)-2-Octadecenal; (E)-5-Tetradecenal; (E)-9-Octadecen-1-ol; (Z)-5-Tetradecen-1-ol; (E)-9-Octadecenyl acetate; (Z)-5-Tetradecenyl acetate; (E)-9-Octadecenal; (Z)-5-Tetradecenal; (Z)-9-Octadecen-1-ol; (E)-6-Tetradecenyl acetate; (Z)-9-Octadecenyl acetate; (Z)-6-Tetradecenyl acetate; (Z)-9-Octadecenal; (E)-7-Tetradecen-1-ol; (E)-11-Octadecen-1-ol; (E)-7-Tetradecenyl acetate; (E)-11-Octadecenal; (Z)-7-Tetradecen-1-ol; (Z)-11-Octadecen-1-ol; (Z)-7-Tetradecenyl acetate; (Z)-11-Octadecenyl acetate; (Z)-7-Tetradecenal; (Z)-11-Octadecenal; (E)-8-Tetradecenyl acetate; (E)-13-Octadecenyl acetate; (Z)-8-Tetradecen-1-ol; (E)-13-Octadecenal; (Z)-8-Tetradecenyl acetate; (Z)-13-Octadecen-1-ol; (Z)-8-Tetradecenal; (Z)-13-Octadecenyl acetate; (E)-9-Tetradecen-1-ol; (Z)-13-Octadecenal; (E)-9-Tetradecenyl acetate; (E)-14-Octadecenal; (Z)-9-Tetradecen-1-ol; (E,Z)-2,13-Octadecadien-1-ol; (Z)-9-Tetradecenyl acetate; (E,Z)-2,13-Octadecadienyl acetate; (Z)-9-Tetradecenal; (E,Z)-2,13-Octadecadienal; (E)-10-Tetradecenyl acetate; (Z,E)-2,13-Octadecadienyl acetate; (Z)-10-Tetradecenyl acetate; (Z,Z)-2,13-Octadecadien-1-ol; (E)-11-Tetradecen-1-ol; (Z,Z)-2,13-Octadecadienyl acetate; (E)-11-Tetradecenyl acetate; (E,E)-3,13-Octadecadienyl acetate; (E)-11-Tetradecenal; (E,Z)-3,13-Octadecadienyl acetate; (Z)-11-Tetradecen-1-ol; (E,Z)-3,13-Octadecadienal; (Z)-11-Tetradecenyl acetate; (Z,E)-3,13-Octadecadienyl acetate; (Z)-11-Tetradecenal; (Z,Z)-3,13-Octadecadienyl acetate; (E)-12-Tetradecenyl acetate; (Z,Z)-3,13-Octadecadienal; (Z)-12-Tetradecenyl acetate; (E,E)-5,9-Octadecadien-1-ol; (E,E)-2,4-Tetradecadienal; (E,E)-5,9-Octadecadienyl acetate; (E,E)-3,5-Tetradecadienyl acetate; (E,E)-9,12-Octadecadien-1-ol; (E,Z)-3,5-Tetradecadienyl acetate; (Z,Z)-9,12-Octadecadienyl acetate; (Z,E)-3,5-Tetradecadienyl acetate; (Z,Z)-9,12-Octadecadienal; (E,Z)-3,7-Tetradecadienyl acetate; (Z,Z)-11,13-Octadecadienal; (E,Z)-3,8-Tetradecadienyl acetate; (E,E)-11,14-Octadecadienal; (E,Z)-4,9-Tetradecadienyl acetate; (Z,Z)-13,15-Octadecadienal; (E,Z)-4,9-Tetradecadienal; (Z,Z,Z)-3,6,9-Octadecatrienyl acetate; (E,Z)-4,10-Tetradecadienyl acetate; (E,E,E)-9,12,15-Octadecatrien-1-ol; (E,E)-5,8-Tetradecadienal; (Z,Z,Z)-9,12,15-Octadecatrienyl acetate; (Z,Z)-5,8-Tetradecadien-1-ol; (Z,Z,Z)-9,12,15-Octadecatrienal; (Z,Z)-5,8-Tetradecadienyl acetate; (Z,Z)-5,8-Tetradecadienal; (E,E)-8,10-Tetradecadien-1-ol; (E,E)-8,10-Tetradecadienyl acetate; (E,E)-8,10-Tetradecadienal; (E,Z)-8,10-Tetradecadienyl acetate; (E,Z)-8,10-Tetradecadienal; (Z,E)-8,10-Tetradecadien-1-ol; (Z,E)-8,10-Tetradecadienyl acetate; (Z,Z)-8,10-Tetradecadienal; (E,E)-9,11-Tetradecadienyl acetate; (E,Z)-9,11-Tetradecadienyl acetate; (Z,E)-9,11-Tetradecadien-1-ol; (Z,E)-9,11-Tetradecadienyl acetate; (Z,E)-9,11-Tetradecadienal; (Z,Z)-9,11-Tetradecadien-1-ol; (Z,Z)-9,11-Tetradecadienyl acetate; (Z,Z)-9,11-Tetradecadienal; (E,E)-9,12-Tetradecadienyl acetate; (Z,E)-9,12-Tetradecadien-1-ol; (Z,E)-9,12-Tetradecadienyl acetate; (Z,E)-9,12-Tetradecadienal; (Z,Z)-9,12-Tetradecadien-1-ol; and (Z,Z)-9,12-Tetradecadienyl acetate.

### BRIEF DESCRIPTION OF THE DRAWINGS

FIG. 1 includes a schematic representation of polyurea capsule formation;

FIG. 2 illustrates residual AI profiles of the formulations from Examples 1-6;

FIG. 3 includes a schematic representation of melamine, urea, formaldehyde condensation to form a MUF prepolymer;

FIG. 4 includes a schematic of microcapsule formation;

FIG. 5 illustrates particle size distribution of 3:1 MUF microcapsules;

FIG. 6 illustrates particle size distribution of 5:1 MUF microcapsules;

FIG. 7 includes microscope images of the 3:1 MUF microcapsules;

FIG. 8 includes microscope images of the 5:1 MUF microcapsules;

FIGs. 9a and 9b include schematic representations of MUF prepolymer and PUR capsule formation;

FIGs. 10a and 10b include schematic representations of PUR microcapsule formation and PUR-MUF hybrid microcapsule formation;

FIG. 11 illustrates particle size distribution of final PUR-MUF microcapsules;

FIG. 12 includes microscope images of PUR-MUF hybrid microcapsules;

FIGs. 13a and 13b include microscope images of MUF microcapsules;

FIGS. 14a through 14d include microscope images of PUR-MUF microcapsules;

FIG. 15 illustrates residual AI profiles of the formulation with chamber aging;

FIG. 16 illustrates ratios of Z9-14:OAc to Z11-16:Oac after three days of release;

FIGS. 17a through 17c illustrate a three day release with residual AI analysis for synthesized microcapsules;

FIG. 18 includes a microscope image of PUR microcapsule formulations;

FIGS. 19a and 19b illustrate residual AI profiles of microcapsules over time;

FIG. 20 illustrates capsule stability and heat resistance;

FIGS. 21 and 22 illustrate capsule release rates and Z8/Z11 ratios over time; and

FIG. 23 illustrates percent of moths contacting the septa at 3, 7, 11, and 14 days after application.

### MODE(S) FOR CARRYING OUT THE INVENTION

Active Ingredients

The agrochemical compositions of the present disclosure comprise an active ingredient. Persons skilled in the art can select the type and amount an active ingredient, or mixture of active ingredients (such as a pheromone), that, when used in an agrochemical composition of the present disclosure (infra), is effective for a particular agricultural application (such as the control of Spodoptera frugiperda (fall armyworm)). The following active ingredients are non-limiting examples of active ingredients that may be used, alone or in combination, in the agrochemical compositions of the present disclosure.

In certain embodiments, the active ingredient comprises a semiochemical. In embodiments, the semiochemical comprises allomone, a kairomone, a pheromone, and mixtures thereof. In particular embodiments, the semiochemical comprises a pheromone. Most pheromones comprise a hydrocarbon skeleton with the terminal hydrogen substituted by a functional group (Ryan MF (2002). Insect Chemoreception. Fundamental and Applied. Kluwer Academic Publishers). The presence of one or more double bonds, generated by the loss of hydrogens from adjacent carbons, determines the degree of unsaturation of the molecule and alters the designation of a hydrocarbon from -ane (no multiple bonds) to -ene. The presence of two and three double bonds is indicated by ending the name with -diene and -triene, respectively. The position of each double bond is represented by a numeral corresponding to that of the carbon from which it begins, with each carbon numbered from that attached to the functional group. The carbon to which the functional group is attached is designated -1-. Pheromones may have, but are not limited to, hydrocarbon chain lengths numbering 10 (deca-), 12 (dodeca-), 14 (tetradeca-), 16 (hexadeca-), or 18 (octadeca-) carbons long. The presence of a double bond has another effect. It precludes rotation of the molecule by fixing it in one of two possible configurations, each representing geometric isomers that are different molecules. These are designated either E (from the German word Entgegen, opposite) or Z (Zusammen, together), when the carbon chains are connected on the opposite (trans) or same (cis) side, respectively, of the double bond.

In other embodiments, the pheromone comprises one or more of a sex, trail, territory, or aggregation pheromone.

In some embodiments, sex pheromones include the C₆-C₂₀ pheromones described in Table 1. In embodiments, the compositions of the present disclosure comprise a sex pheromone described in Table 1. In embodiments, the compositions of the present disclosure comprise a mixture of sex pheromone in Table 1.

TABLE 1
Sex Pheromones of the Present Disclosure

| Name | Name |
|---|---|
| (E)-2-Decen-1-ol | (Z,E)-9,11-Tetradecadien-1-ol |
| (E)-2-Decenyl acetate | (Z,E)-9,11-Tetradecadienyl acetate |
| (E)-2-Decenal | (Z,E)-9,11-Tetradecadienal |
| (Z)-2-Decen-1-ol | (Z,Z)-9,11-Tetradecadien-1-ol |
| (Z)-2-Decenyl acetate | (Z,Z)-9,11-Tetradecadienyl acetate |
| (Z)-2-Decenal | (Z,Z)-9,11-Tetradecadienal |
| (E)-3-Decen-1-ol | (E,E)-9,12-Tetradecadienyl acetate |
| (Z)-3-Decenyl acetate | (Z,E)-9,12-Tetradecadien-1-ol |
| (Z)-3-Decen-1-ol | (Z,E)-9,12-Tetradecadienyl acetate |
| (Z)-4-Decen-1-ol | (Z,E)-9,12-Tetradecadienal |
| (E)-4-Decenyl acetate | (Z,Z)-9,12-Tetradecadien-1-ol |
| (Z)-4-Decenyl acetate | (Z,Z)-9,12-Tetradecadienyl acetate |
| (Z)-4-Decenal | (E,E)-10,12-Tetradecadien-1-ol |
| (E)-5-Decen-1-ol | (E,E)-10,12-Tetradecadienyl acetate |
| (E)-5-Decenyl acetate | (E,E)-10,12-Tetradecadienal |
| (Z)-5-Decen-1-ol | (E,Z)-10,12-Tetradecadienyl acetate |
| (Z)-5-Decenyl acetate | (Z,E)-10,12-Tetradecadienyl acetate |
| (Z)-5-Decenal | (Z,Z)-10,12-Tetradecadien-1-ol |
| (E)-7-Decenyl acetate | (Z,Z)-10,12-Tetradecadienyl acetate |
| (Z)-7-Decenyl acetate | (E,Z,Z)-3,8,11-Tetradecatrienyl acetate |
| (E)-8-Decen-1-ol | (E)-8-Pentadecen-1-ol |
| (E,E)-2,4-Decadienal | (E)-8-Pentadecenyl acetate |
| (E,Z)-2,4-Decadienal | (Z)-8-Pentadecen-1-ol |
| (Z,Z)-2,4-Decadienal | (Z)-8-Pentadecenyl acetate |
| (E,E)-3,5-Decadienyl acetate | (Z)-9-Pentadecenyl acetate |
| (Z,E)-3,5-Decadienyl acetate | (E)-9-Pentadecenyl acetate |
| (Z,Z)-4,7-Decadien-1-ol | (Z)-10-Pentadecenyl acetate |
| (Z,Z)-4,7-Decadienyl acetate | (Z)-10-Pentadecenal |
| (E)-2-Undecenyl acetate | (E)-12-Pentadecenyl acetate |
| (E)-2-Undecenal | (Z)-12-Pentadecenyl acetate |
| (Z)-5-Undecenyl acetate | (Z,Z)-6,9-Pentadecadien-1-ol |
| (Z)-7-Undecenyl acetate | (Z,Z)-6,9-Pentadecadienyl acetate |
| (Z)-8-Undecenyl acetate | (Z,Z)-6,9-Pentadecadienal |
| (Z)-9-Undecenyl acetate | (E,E)-8,10-Pentadecadienyl acetate |
| (E)-2-Dodecenal | (E,Z)-8,10-Pentadecadien-1-ol |
| (Z)-3-Dodecen-1-ol | (E,Z)-8,10-Pentadecadienyl acetate |
| (E)-3-Dodecenyl acetate | (Z,E)-8,10-Pentadecadienyl acetate |
| (Z)-3-Dodecenyl acetate | (Z,Z)-8,10-Pentadecadienyl acetate |
| (E)-4-Dodecenyl acetate | (E,Z)-9,11-Pentadecadienal |
| (E)-5-Dodecen-1-ol | (Z,Z)-9,11-Pentadecadienal |
| (E)-5-Dodecenyl acetate | (Z)-3-Hexadecenyl acetate |
| (Z)-5-Dodecen-1-ol | (E)-5-Hexadecen-1-ol |
| (Z)-5-Dodecenyl acetate | (E)-5-Hexadecenyl acetate |
| (Z)-5-Dodecenal | (Z)-5-Hexadecen-1-ol |
| (E)-6-Dodecen-1-ol | (Z)-5-Hexadecenyl acetate |
| (Z)-6-Dodecenyl acetate | (E)-6-Hexadecenyl acetate |
| (E)-6-Dodecenal | (E)-7-Hexadecen-1-ol |
| (E)-7-Dodecen-1-ol | (E)-7-Hexadecenyl acetate |
| (E)-7-Dodecenyl acetate | (E)-7-Hexadecenal |
| (E)-7-Dodecenal | (Z)-7-Hexadecen-1-ol |
| (Z)-7-Dodecen-1-ol | (Z)-7-Hexadecenyl acetate |
| (Z)-7-Dodecenyl acetate | (Z)-7-Hexadecenal |
| (Z)-7-Dodecenal | (E)-8-Hexadecenyl acetate |
| (E)-8-Dodecen-1-ol | (E)-9-Hexadecen-1-ol |
| (E)-8-Dodecenyl acetate | (E)-9-Hexadecenyl acetate |
| (E)-8-Dodecenal | (E)-9-Hexadecenal |
| (Z)-8-Dodecen-1-ol | (Z)-9-Hexadecen-1-ol |
| (Z)-8-Dodecenyl acetate | (Z)-9-Hexadecenyl acetate |
| (E)-9-Dodecen-1-ol | (Z)-9-Hexadecenal |
| (E)-9-Dodecenyl acetate | (E)-10-Hexadecen-1-ol |
| (E)-9-Dodecenal | (E)-10-Hexadecenal |
| (Z)-9-Dodecen-1-ol | (Z)-10-Hexadecenyl acetate |
| (Z)-9-Dodecenyl acetate | (Z)-10-Hexadecenal |
| (Z)-9-Dodecenal | (E)-11-Hexadecen-1-ol |
| (E)-10-Dodecen-1-ol | (E)-11-Hexadecenyl acetate |
| (E)-10-Dodecenyl acetate | (E)-11-Hexadecenal |
| (E)-10-Dodecenal | (Z)-11-Hexadecen-1-ol |
| (Z)-10-Dodecen-1-ol | (Z)-11-Hexadecenyl acetate |
| (Z)-10-Dodecenyl acetate | (Z)-11-Hexadecenal |
| (E,Z)-3,5-Dodecadienyl acetate | (Z)-12-Hexadecenyl acetate |
| (Z,E)-3,5-Dodecadienyl acetate | (Z)-12-Hexadecenal |
| (Z,Z)-3,6-Dodecadien-1-ol | (E)-14-Hexadecenal |
| (E,E)-4,10-Dodecadienyl acetate | (Z)-14-Hexadecenyl acetate |
| (E,E)-5,7-Dodecadien-1-ol | (E,E)-1,3-Hexadecadien-1-ol |
| (E,E)-5,7-Dodecadienyl acetate | (E,Z)-4,6-Hexadecadien-1-ol |
| (E,Z)-5,7-Dodecadien-1-ol | (E,Z)-4,6-Hexadecadienyl acetate |
| (E,Z)-5,7-Dodecadienyl acetate | (E,Z)-4,6-Hexadecadienal |
| (E,Z)-5,7-Dodecadienal | (E,Z)-6,11-Hexadecadienyl acetate |
| (Z,E)-5,7-Dodecadien-1-ol | (E,Z)-6,11-Hexadecadienal |
| (Z,E)-5,7-Dodecadienyl acetate | (Z,Z)-7,10-Hexadecadien-1-ol |
| (Z,E)-5,7-Dodecadienal | (Z,Z)-7,10-Hexadecadienyl acetate |
| (Z,Z)-5,7-Dodecadienyl acetate | (Z,E)-7,11-Hexadecadien-1-ol |
| (Z,Z)-5,7-Dodecadienal | (Z,E)-7,11-Hexadecadienyl acetate |
| (E,E)-7,9-Dodecadienyl acetate | (Z,E)-7,11-Hexadecadienal |
| (E,Z)-7,9-Dodecadien-1-ol | (Z,Z)-7,11-Hexadecadien-1-ol |
| (E,Z)-7,9-Dodecadienyl acetate | (Z,Z)-7,11-Hexadecadienyl acetate |
| (E,Z)-7,9-Dodecadienal | (Z,Z)-7,11-Hexadecadienal |
| (Z,E)-7,9-Dodecadien-1-ol | (Z,Z)-8,10-Hexadecadienyl acetate |
| (Z,E)-7,9-Dodecadienyl acetate | (E,Z)-8,11-Hexadecadienal |
| (Z,Z)-7,9-Dodecadien-1-ol | (E,E)-9,11-Hexadecadienal |
| (Z,Z)-7,9-Dodecadienyl acetate | (E,Z)-9,11-Hexadecadienyl acetate |
| (E,E)-8,10-Dodecadien-1-ol | (E,Z)-9,11-Hexadecadienal |
| (E,E)-8,10-Dodecadienyl acetate | (Z,E)-9,11-Hexadecadienal |
| (E,E)-8,10-Dodecadienal | (Z,Z)-9,11-Hexadecadienal |
| (E,Z)-8,10-Dodecadien-1-ol | (E,E)-10,12-Hexadecadien-1-ol |
| (E,Z)-8,10-Dodecadienyl acetate | (E,E)-10,12-Hexadecadienyl acetate |
| (E,Z)-8,10-Dodecadienal | (E,E)-10,12-Hexadecadienal |
| (Z,E)-8,10-Dodecadien-1-ol | (E,Z)-10,12-Hexadecadien-1-ol |
| (Z,E)-8,10-Dodecadienyl acetate | (E,Z)-10,12-Hexadecadienyl acetate |
| (Z,E)-8,10-Dodecadienal | (E,Z)-10,12-Hexadecadienal |
| (Z,Z)-8,10-Dodecadien-1-ol | (Z,E)-10,12-Hexadecadienyl acetate |
| (Z,Z)-8,10-Dodecadienyl acetate | (Z,E)-10,12-Hexadecadienal |
| (Z,E,E)-3,6,8-Dodecatrien-1-ol | (Z,Z)-10,12-Hexadecadienal |
| (Z,Z,E)-3,6,8-Dodecatrien-1-ol | (E,E)-11,13-Hexadecadien-1-ol |
| (E)-2-Tridecenyl acetate | (E,E)-11,13-Hexadecadienyl acetate |
| (Z)-2-Tridecenyl acetate | (E,E)-11,13-Hexadecadienal |
| (E)-3-Tridecenyl acetate | (E,Z)-11,13-Hexadecadien-1-ol |
| (E)-4-Tridecenyl acetate | (E,Z)-11,13-Hexadecadienyl acetate |
| (Z)-4-Tridecenyl acetate | (E,Z)-11,13-Hexadecadienal |
| (Z)-4-Tridecenal | (Z,E)-11,13-Hexadecadien-1-ol |
| (E)-6-Tridecenyl acetate | (Z,E)-11,13-Hexadecadienyl acetate |
| (Z)-7-Tridecenyl acetate | (Z,E)-11,13-Hexadecadienal |
| (E)-8-Tridecenyl acetate | (Z,Z)-11,13-Hexadecadien-1-ol |
| (Z)-8-Tridecenyl acetate | (Z,Z)-11,13-Hexadecadienyl acetate |
| (E)-9-Tridecenyl acetate | (Z,Z)-11,13-Hexadecadienal |
| (Z)-9-Tridecenyl acetate | (E,E)-10,14-Hexadecadienal |
| (Z)-10-Tridecenyl acetate | (Z,E)-11,14-Hexadecadienyl acetate |
| (E)-11-Tridecenyl acetate | (E,E,Z)-4,6,10-Hexadecatrien-1-ol |
| (Z)-11-Tridecenyl acetate | (E,E,Z)-4,6,10-Hexadecatrienyl acetate |
| (E,Z)-4,7-Tridecadienyl acetate | (E,Z,Z)-4,6,10-Hexadecatrien-1-ol |
| (Z,Z)-4,7-Tridecadien-1-ol | (E,Z,Z)-4,6,10-Hexadecatrienyl acetate |
| (Z,Z)-4,7-Tridecadienyl acetate | (E,E,Z)-4,6,11-Hexadecatrienyl acetate |
| (E,Z)-5,9-Tridecadienyl acetate | (E,E,Z)-4,6,11-Hexadecatrienal |
| (Z,E)-5,9-Tridecadienyl acetate | (Z,Z,E)-7,11,13-Hexadecatrienal |
| (Z,Z)-5,9-Tridecadienyl acetate | (E,E,E)-10,12,14-Hexadecatrienyl acetate |
| (Z,Z)-7,11-Tridecadienyl acetate | (E,E,E)-10,12,14-Hexadecatrienal |
| (E,Z,Z)-4,7,10-Tridecatrienyl acetate | (E,E,Z)-10,12,14-Hexadecatrienyl acetate |
| (E)-3-Tetradecen-1-ol | (E,E,Z)-10,12,14-Hexadecatrienal |
| (E)-3-Tetradecenyl acetate | (E,E,Z,Z)-4,6,11,13-Hexadecatetraenal |
| (Z)-3-Tetradecen-1-ol | (E)-2-Heptadecenal |
| (Z)-3-Tetradecenyl acetate | (Z)-2-Heptadecenal |
| (E)-5-Tetradecen-1-ol | (E)-8-Heptadecen-1-ol |
| (E)-5-Tetradecenyl acetate | (E)-8-Heptadecenyl acetate |
| (E)-5-Tetradecenal | (Z)-8-Heptadecen-1-ol |
| (Z)-5-Tetradecen-1-ol | (Z)-9-Heptadecenal |
| (Z)-5-Tetradecenyl acetate | (E)-10-Heptadecenyl acetate |
| (Z)-5-Tetradecenal | (Z)-11-Heptadecen-1-ol |
| (E)-6-Tetradecenyl acetate | (Z)-11-Heptadecenyl acetate |
| (Z)-6-Tetradecenyl acetate | (E,E)-4,8-Heptadecadienyl acetate |
| (E)-7-Tetradecen-1-ol | (Z,Z)-8,10-Heptadecadien-1-ol |
| (E)-7-Tetradecenyl acetate | (Z,Z)-8,11-Heptadecadienyl acetate |
| (Z)-7-Tetradecen-1-ol | (E)-2-Octadecenyl acetate |
| (Z)-7-Tetradecenyl acetate | (E)-2-Octadecenal |
| (Z)-7-Tetradecenal | (Z)-2-Octadecenyl acetate |
| (E)-8-Tetradecenyl acetate | (Z)-2-Octadecenal |
| (Z)-8-Tetradecen-1-ol | (E)-9-Octadecen-1-ol |
| (Z)-8-Tetradecenyl acetate | (E)-9-Octadecenyl acetate |
| (Z)-8-Tetradecenal | (E)-9-Octadecenal |
| (E)-9-Tetradecen-1-ol | (Z)-9-Octadecen-1-ol |
| (E)-9-Tetradecenyl acetate | (Z)-9-Octadecenyl acetate |
| (Z)-9-Tetradecen-1-ol | (Z)-9-Octadecenal (Z9-18Ald) |
| (Z)-9-Tetradecenyl acetate | (E)-11-Octadecen-1-ol |
| (Z)-9-Tetradecenal | (E)-11-Octadecenal |
| (E)-10-Tetradecenyl acetate | (Z)-11-Octadecen-1-ol |
| (Z)-10-Tetradecenyl acetate | (Z)-11-Octadecenyl acetate |
| (E)-11-Tetradecen-1-ol | (Z)-11-Octadecenal |
| (E)-11-Tetradecenyl acetate | (E)-13-Octadecenyl acetate |
| (E)-11-Tetradecenal | (E)-13-Octadecenal |
| (Z)-11-Tetradecen-1-ol | (Z)-13-Octadecen-1-ol |
| (Z)-11-Tetradecenyl acetate | (Z)-13-Octadecenyl acetate |
| (Z)-11-Tetradecenal | (Z)-13-Octadecenal |
| (E)-12-Tetradecenyl acetate | (E)-14-Octadecenal |
| (Z)-12-Tetradecenyl acetate | (E,Z)-2,13-Octadecadien-1-ol |
| (E,E)-2,4-Tetradecadienal | (E,Z)-2,13-Octadecadienyl acetate |
| (E,E)-3,5-Tetradecadienyl acetate | (E,Z)-2,13-Octadecadienal |
| (E,Z)-3,5-Tetradecadienyl acetate | (Z,E)-2,13-Octadecadienyl acetate |
| (Z,E)-3,5-Tetradecadienyl acetate | (Z,Z)-2,13-Octadecadien-1-ol |
| (E,Z)-3,7-Tetradecadienyl acetate | (Z,Z)-2,13-Octadecadienyl acetate |
| (E,Z)-3,8-Tetradecadienyl acetate | (E,E)-3,13-Octadecadienyl acetate |
| (E,Z)-4,9-Tetradecadienyl acetate | (E,Z)-3,13-Octadecadienyl acetate |
| (E,Z)-4,9-Tetradecadienal | (E,Z)-3,13-Octadecadienal |
| (E,Z)-4,10-Tetradecadienyl acetate | (Z,E)-3,13-Octadecadienyl acetate |
| (E,E)-5,8-Tetradecadienal | (Z,Z)-3,13-Octadecadienyl acetate |
| (Z,Z)-5,8-Tetradecadien-1-ol | (Z,Z)-3,13-Octadecadienal |
| (Z,Z)-5,8-Tetradecadienyl acetate | (E,E)-5,9-Octadecadien-1-ol |
| (Z,Z)-5,8-Tetradecadienal | (E,E)-5,9-Octadecadienyl acetate |
| (E,E)-8,10-Tetradecadien-1-ol | (E,E)-9,12-Octadecadien-1-ol |
| (E,E)-8,10-Tetradecadienyl acetate | (Z,Z)-9,12-Octadecadienyl acetate |
| (E,E)-8,10-Tetradecadienal | (Z,Z)-9,12-Octadecadienal |
| (E,Z)-8,10-Tetradecadienyl acetate | (Z,Z)-11,13-Octadecadienal |
| (E,Z)-8,10-Tetradecadienal | (E,E)-11,14-Octadecadienal |
| (Z,E)-8,10-Tetradecadien-1-ol | (Z,Z)-13,15-Octadecadienal |
| (Z,E)-8,10-Tetradecadienyl acetate | (Z,Z,Z)-3,6,9-Octadecatrienyl acetate |
| (Z,Z)-8,10-Tetradecadienal | (E,E,E)-9,12,15-Octadecatrien-1-ol |
| (E,E)-9,11-Tetradecadienyl acetate | (Z,Z,Z)-9,12,15-Octadecatrienyl acetate |
| (E,Z)-9,11-Tetradecadienyl acetate | (Z,Z,Z)-9,12,15-Octadecatrienal |
| (3E,8Z,11Z)-tetradecatrien-1-yl acetate | (3E,8Z)-tetradecadien-1-yl acetate |

In alternative embodiments, sex pheromones include the C₆-C₂₀ pheromones described in Table 2. In embodiments, the compositions of the present disclosure comprise a sex pheromone described in Table 2. In embodiments, the compositions of the present disclosure comprise a mixture of sex pheromone in Table 2.

TABLE 2
Sex Pheromones of the Present Disclosure

| Name | Structure |
|---|---|
| (Z)-3-hexen-1-ol | 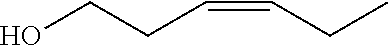 |
| (Z)-3-nonen-1-ol | 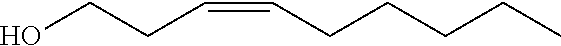 |
| (Z)-5-decen-1-ol | 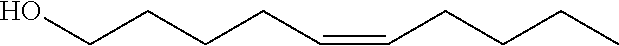 |
| (Z)-5-decenyl acetate | 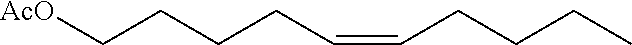 |
| (E)-5-decen-1-ol | 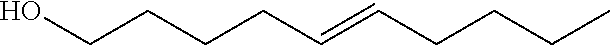 |
| (E)-5-decenyl acetate | 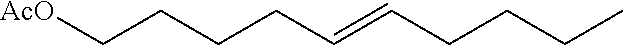 |
| (Z)-7-dodecen-1-ol | 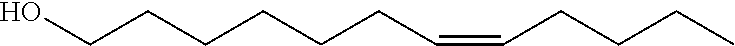 |
| (Z)-7-dodecenyl acetate | 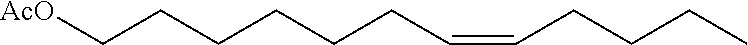 [SMILES: CCCC/C=C\CCCCCCOC(C)=O] |
| (E)-8-dodecen-1-ol | 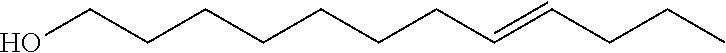 |
| (E)-8-dodecenyl acetate | 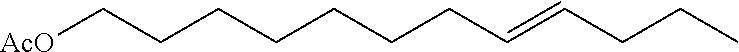 [SMILES: CCC/C=C/CCCCCCCOC(C)=O] |
| (Z)-8-dodecen-1-ol | 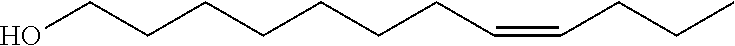 |
| (Z)-8-dodecenyl acetate | 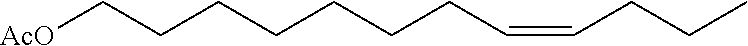 [SMILES: CCC/C=C\CCCCCCCOC(C)=O] |
| (Z)-9-dodecen-1-ol | 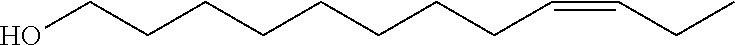 |
| (Z)-9-dodecenyl acetate | 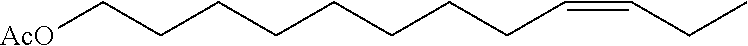 [SMILES: CC/C=C\CCCCCCCCOC(C)=O] |
| (Z)-9-Octadecenal | 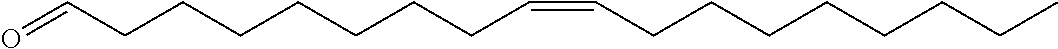 [SMILES: CCCCCCCC/C=C\CCCCCCCC=O] |
| (E,E)-8,10-dodecadien-1-ol | 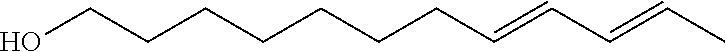 |
| (7E,9Z)-dodecadienyl acetate | 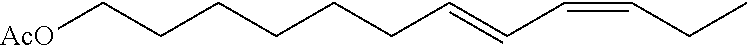 [SMILES: CC/C=C\C=C\CCCCCCOC(C)=O] |
| (Z)-9-tetradecen-1-ol | 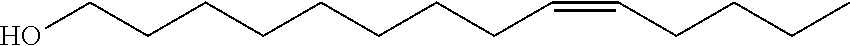 |
| (Z)-9-tetradecenyl acetate | 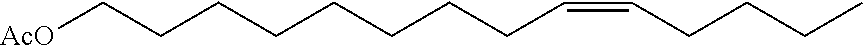 [SMILES: CCCC/C=C\CCCCCCCCOC(C)=O] |
| (Z)-11-tetradecen-1-ol | 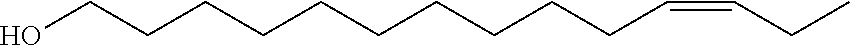 |
| (Z)-11-tetradecenyl acetate | 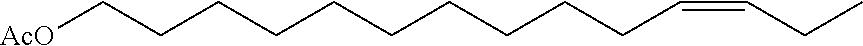 [SMILES: CC/C=C\CCCCCCCCCCOC(C)=O] |
| (E)-11-tetradecen-1-ol | 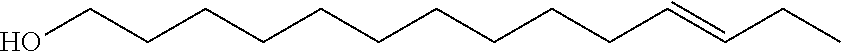 |
| (E)-11-tetradecenyl acetate | 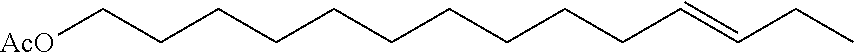 [SMILES: CC/C=C/CCCCCCCCCCOC(C)=O] |
| (Z)-7-hexadecen-1-ol | 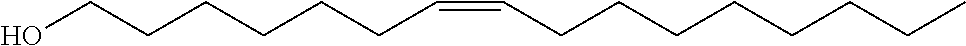 [SMILES: CCCCCCCC/C=C\CCCCCCO] |
| (Z)-7-hexadecenal | 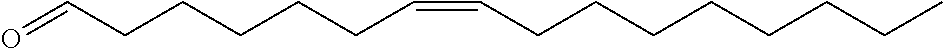 [SMILES: CCCCCCCC/C=C\CCCCCC=O] |
| (Z)-9-hexadecen-1-ol | 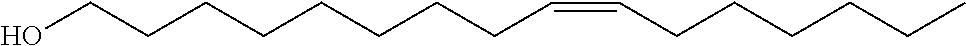 [SMILES: CCCCCC/C=C\CCCCCCCCO] |
| (Z)-9-hexadecenal | 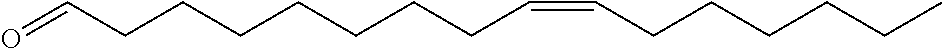 [SMILES: CCCCCC/C=C\CCCCCCCC=O] |
| (Z)-9-hexadecenyl acetate | 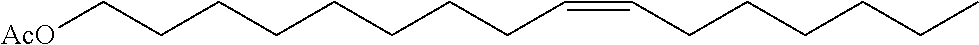 [SMILES: CCCCCC/C=C\CCCCCCCCOC(C)=O] |
| (Z)-11-hexadecen-1-ol | 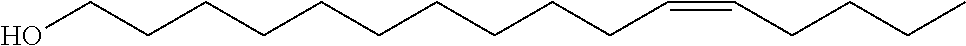 [SMILES: CCCC/C=C\CCCCCCCCCCO] |
| (Z)-11-hexadecenal | 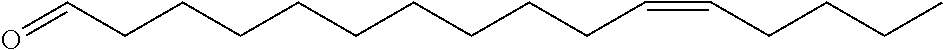 [SMILES: CCCC/C=C\CCCCCCCCCC=O] |
| (Z)-11-hexadecenyl acetate | 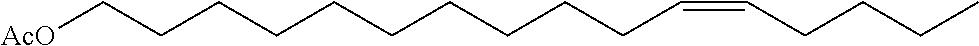 [SMILES: CCCC/C=C\CCCCCCCCCCOC(C)=O] |
| (Z,Z)-11,13-hexadecadienal | 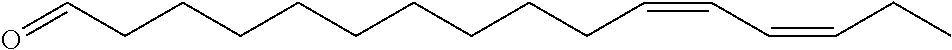 [SMILES: CC/C=C\C=C/CCCCCCCCCC=O] |
| (Z,Z)-11,13-hexadecadien-1-ol | 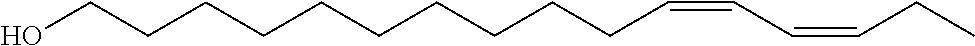 [SMILES: CC/C=C\C=C/CCCCCCCCCCO] |
| (11Z,13E)-hexadecadien-1-ol | 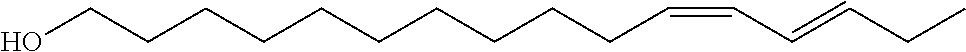 [SMILES: CC/C=C/C=C\CCCCCCCCCCO] |
| (9Z,11E)-hexadecadienal | 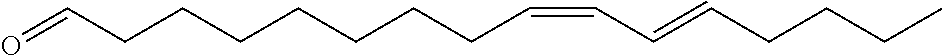 [SMILES: CCCC/C=C/C=C\CCCCCCCC=O] |
| (Z)-13-octadecen-1-ol | 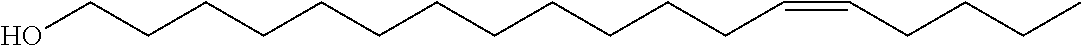 [SMILES: CCCC/C=C\CCCCCCCCCCCCO] |
| (Z)-13-octadecenal | 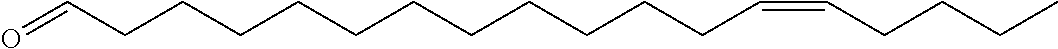 [SMILES: CCCC/C=C\CCCCCCCCCCCC=O] |
| (Z,Z,Z,Z,Z)-3,6,9,12,15- tricosapentaene | 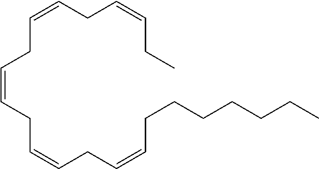 [SMILES: CC/C=C\C/C=C\C/C=C\C/C=C\C/C=C\CCCCCCC] |

In some embodiments, the pheromone in a composition of the present disclosure comprises (Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof.

In other embodiments, the pheromone in a composition of the present disclosure comprises (Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof.

In yet other embodiments, the pheromone in a composition of the present disclosure comprises (Z)-9-Tetradecenyl Acetate (Z9-14Ac), (Z)-11-Hexadecenyl Acetate (Z11-16Ac), and mixtures thereof.

Pests

In some aspects, the present disclosure provides methods for controlling a population of one or more pests in an area (such as a field) where the agrochemical compositions of the present disclosure are applied. Persons skilled in the art can select the type and amount of an active ingredient, or mixture of active ingredients (such as a pheromone), that, when used in an agrochemical composition of the present disclosure, is effective for a particular pest (such Spodoptera frugiperda (fall armyworm)). The following are non-limiting examples of pests that may be controlled using the agrochemical compositions of the present disclosure.

In certain embodiments, the pests comprise one or more insects. In particular embodiments, the pest comprises pests of the Phylum Nematoda. In embodiments, the pest comprises pests of the Phylum Arthropoda. In embodiments, the pest comprises pests of the Subphylum Chelicerata. In embodiments, the pests comprise pets of the Class Arachnida. In embodiments, the pests comprise pests of Subphylum Myriapoda. In embodiments, the pests comprise pests of the Class Symphyla. In embodiments, the pests comprise pests of the Subphylum Hexapoda. In embodiments, the pests comprise pests of the Class Insecta.

In embodiments, the pest comprises Coleoptera (beetles). A non-exhaustive list of these pests includes, but is not limited to, Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp., Cerotoma spp. (chrysomeids), Cerotoma trifurcate (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes Lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hyperapostica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys fuscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus Mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (European chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle), and Zabrus tenebioides.

In other embodiments, the pest comprises Dictyoptera (cockroaches). A non-exhaustive list of these pests includes, but is not limited to, Blattella germanica (German cockroach), Blatta orientalis (oriental cockroach), Parcoblatta pennylvanica, Periplaneta americana (American cockroach), Periplaneta australoasiae (Australian cockroach), Periplaneta brunnea (brown cockroach), Periplaneta fuliginosa (smokybrown cockroach), Pyncoselus suninamensis (Surinam cockroach), and Supella longipalpa (brownbanded cockroach).

In alternative embodiments, the pest comprises Diptera (true flies). A non-exhaustive list of these pests includes, but is not limited to, Aedes spp. (mosquitoes), Agromyzafrontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cochliomyia spp. (screwworms), Contarinia spp. (gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinellafrit (frit fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies), and Tipula spp. (crane flies).

In some embodiments, the pest comprises Hemiptera (true bugs). A non-exhaustive list of these pests includes, but is not limited to, Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus Hesperus (western tarnished plant bug), Maconellicoccus hirsutus, Neurocolpus longirostris, Nezara viridula (southern green stink bug), Phytocoris spp. (plant bugs), Phytocoris ca/fornicus, Phytocoris relativus, Piezodorus guildingi, Poecilocapsus lineatus (fourlined plant bug), Psallus vaccinicola, Pseudacysta perseae, Scaptocoris castanea, and Triatoma spp. (bloodsucking conenose bugs/kissing bugs).

In other embodiments, the pest comprises Homoptera (aphids, scales, whiteflies, leafhoppers). A non-exhaustive list of these pests includes, but is not limited to, Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantia (California red scale), Aphis spp. (aphids), Aphis gossypii (cotton aphid), Aphis pomi (apple aphid), Aulacorthum solani (foxglove aphid), Bemisia spp. (whiteflies), Bemisia argentifoii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchase (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphin (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatellafurcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), and Zulia entreriana.

In alternative embodiments, the pest comprises Hymenoptera (ants, wasps, and bees). A non-exhaustive list of these pests includes, but is not limited to, Acromyrrmex spp., Athalia rosae, Atta spp. (leafcutting ants), Camponotus spp. (carpenter ants), Diprion spp. (sawflies), Formica spp. (ants), Iridomyrmex humilis (Argentine ant), Monomorium ssp., Monomorium minimum (little black ant), Monomorium pharaonic (Pharaoh ant), Neodiprion spp. (sawflies), Pogonomyrmex spp. (harvester ants), Polistes spp. (paper wasps), Solenopsis spp. (fire ants), Tapoinoma sessile (odorous house ant), Tetranomorium spp. (pavement ants), Vespula spp. (yellow jackets), and Xylocopa spp. (carpenter bees).

In some embodiments, the pest comprises Isoptera (termites). A non-exhaustive list of these pests includes, but is not limited to, Coptotermes spp., Coptotermes curvignathus, Coptotermes frenchii, Coptotermesformosanus (Formosan subterranean termite), Cornitermes spp. (nasute termites), Cryptotermes spp. (drywood termites), Heterotermes spp. (desert subterranean termites), Heterotermes aureus, Kalotermes spp. (drywood termites), Incistitermes spp. (drywood termites), Macrotermes spp. (fungus growing termites), Marginitermes spp. (drywood termites), Microcerotermes spp. (harvester termites), Microtermes obesi, Procornitermes spp., Reticulitermes spp. (subterranean termites), Reticulitermes banyulensis, Reticulitermes grassei, Reticulitermesflavipes (eastern subterranean termite), Reticulitermes hageni, Reticulitermes hesperus (western subterranean termite), Reticulitermes santonensis, Reticulitermes speratus, Reticulitermes tibialis, Reticulitermes virginicus, Schedorhinotermes spp., and Zootermopsis spp. (rotten-wood termites).

In other embodiments, the pest comprises Lepidoptera (moths and butterflies). A non-exhaustive list of these pests includes, but is not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabuhfera (jute looper), Anticarsia gemmatalis (velvetbean caterpillar), Archips argyrospila (fruit tree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leaf perforator), Caloptilia spp. (leaf miners), Capua reticulana, Carposina niponensis (peach fruit moth), Chilo spp., Chlumetia transversa (mango shoot borer), Choristoneura rosaceana (oblique banded leaf roller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwestern corn borer), Earias spp. (bollworms), Earias insulata (Egyptian bollworm), Earias vitelli (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobacco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicate (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparanal (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabs, Plodia interpunctella (Indian meal moth), Plutella xylostella (diamondback moth), Polychrosis viteana (grape berry moth), Prays endocarps, Prays oleae (olive moth), Pseudaletia spp. (noctuid moths), Pseudaletia unipunctata (armyworm), Pseudoplusia includens (soybean looper), Rachiplusia nu, Scirpophaga incertulas (yellow stemborer), Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera frugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), and Zeuzerapyrina (leopard moth).

In particular embodiments, the pest comprises Mallophaga (chewing lice). A non-exhaustive list of these pests includes, but is not limited to, Bovicola ovis (sheep biting louse), Menacanthus stramineus (chicken body louse), and Menopon gallinea (common hen louse).

In other embodiments, the pest comprises Orthoptera (grasshoppers, locusts, and crickets). A non-exhaustive list of these pests includes, but is not limited to, Anabrus simplex (Mormon cricket), Gryllotalpidae (mole crickets), Locusta migratoria, Melanoplus spp. (grasshoppers), Microcentrum retinerve (angular winged katydid), Pterophylla spp. (katydids), chistocerca gregaria, Scudderia furcate (fork tailed bush katydid), and Valanga nigricorni.

In alternative embodiments, the pest comprises Phthiraptera (sucking lice). A non-exhaustive list of these pests includes, but is not limited to, Haematopinus spp. (cattle and hog lice), Linognathus ovillus (sheep louse), Pediculus humanus capitis (human body louse), Pediculus humanus (human body lice), and Pthirus pubis (crab louse).

In other embodiments, the pest comprises Siphonaptera (fleas). A non-exhaustive list of these pests includes, but is not limited to, Ctenocephalides canis (dog flea), Ctenocephalidesfelis (cat flea), and Pulex irritans (human flea).

In some embodiments, the pest comprises Thysanoptera (thrips). A non-exhaustive list of these pests includes, but is not limited to, Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, and Thrips spp.

In other embodiments, the pest comprises Thysanura (bristletails). A non-exhaustive list of these pests includes, but is not limited to, Lepisma spp. (silverfish) and Thermobia spp. (firebrats).

In other embodiments, the pest comprises Acarina (mites and ticks). A non-exhaustive list of these pests includes, but is not limited to, Acarapsis woodi (tracheal mite of honeybees), Acarus spp. (food mites), Acarus siro (grain mite), Aceria mangiferae (mango bud mite), Aculops spp., Aculops lycopersici (tomato russet mite), Aculops pelekasi, Aculus pelekassi, Aculus schlechtendali (apple rust mite), Amblyomma Americanum (lone star tick), Boophilus spp. (ticks), Brevipalpus obovatus (privet mite), Brevipalpus phoenicis (red and black flat mite), Demodex spp. (mange mites), Dermacentor spp. (hard ticks), Dermacentor variabilis (American dog tick), Dermatophagoides pteronyssinus (house dust mite), Eotetranycus spp., Eotetranychus carpini (yellow spider mite), Epitimerus spp., Eriophyes spp., Ixodes spp. (ticks), Metatetranycus spp., Notoedres cati, Oligonychus spp., Oligonychus coffee, Oligonychus ilicus (southern red mite), Panonychus spp., Panonychus citri (citrus red mite), Panonychus ulmi (European red mite), Phyllocoptruta oleivora (citrus rust mite), Polyphagotarsonemun latus (broad mite), Rhipicephalus sanguineus (brown dog tick), Rhizoglyphus spp. (bulb mites), Sarcoptes scabiei (itch mite), Tegolophus perseaflorae, Tetranychus spp., Tetranychus urticae (two-spotted spider mite), and Varroa destructor (honey bee mite).

In other embodiments, the pest comprises Nematoda (nematodes). A non-exhaustive list of these pests includes, but is not limited to, Aphelenchoides spp. (bud and leaf & pine wood nematodes), Belonolaimus spp. (sting nematodes), Criconemella spp. (ring nematodes), Dirofilaria immitis (dog heartworm), Ditylenchus spp. (stem and bulb nematodes), Heterodera spp. (cyst nematodes), Heterodera zeae (corn cyst nematode), Hirschmanniella spp. (root nematodes), Hoplolaimus spp. (lance nematodes), Meloidogyne spp. (root knot nematodes), Meloidogyne incognita (root knot nematode), Onchocerca volvulus (hook-tail worm), Pratylenchus spp. (lesion nematodes), Radopholus spp. (burrowing nematodes), and Rotylenchus reniformis (kidney-shaped nematode).

In other embodiments, the pest comprises Symphyla (symphylans). A non-exhaustive list of these pests includes, but is not limited to, Scutigerella immaculata.

Agrochemical Compositions

In one aspect, the present disclosure provides controlled-release agrochemical compositions. In some embodiments, the compositions of the present disclosure provide slow release of an active ingredient into the atmosphere, and/or so as to be protected from degradation following release. In embodiments, the compositions of the present disclosure are biodegradable.

In other embodiments, a composition of the present disclosure comprises: (a) a matrix; (b) an active ingredient composition contained within the matrix. In embodiments, the composition further comprises (c) a filler contained within the matrix.

In particular embodiments, the matrix comprises a binder. In embodiments, the binder comprises one or more polymers. In embodiments, the binder is a biodegradable polymer.

In some embodiments, the binder comprises one or more biodegradable polymers. In embodiments, the binder is polycaprolactone (PCL), poly(butylene adipate-co-terephthalate) (PBAT), polybutylene succinate (PBS), polyhydroxyalkanoate (PHA), polylactic acid (PLA), or mixtures thereof. In embodiments, the biodegradable polymer is PCL. In embodiments, the biodegradable polymer is PLA.

In other embodiments, the binder comprises one or more non-biodegradable polymers. In embodiments, the non-biodegradable polymer is low density polyethylene (LDPE), ethylene-vinyl acetate (EVA), high density polyethylene (HDPE), polyvinyl acetate (PVA), or mixtures thereof.

In some embodiments, a composition of the present disclosure comprises from about 10 wt % to about 98 wt % of a binder, e.g., about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In alternative embodiments, the composition comprises from about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of a binder.

In particular embodiments, the compositions of the present disclosure comprise a filler. In embodiments, the filler is contained within the matrix. In embodiments, the matrix comprises a binder and the filler is contained within the binder.

In other embodiments, the filler is clay, a zeolite, talcum, shredded hay, cotton, cork, hemp, wood chips, wood dust, wood excelsior, microcrystalline cellulose, paper pulp, kaolin, calcined kaolin, chitosan, or mixture thereof. In embodiments, the clay is organoclay.

In other embodiments, the filler comprises microcrystalline cellulose. In embodiments, the filler comprises kaolin. In embodiments, the filler comprises calcined kaolin.

In alternative embodiments, the filler comprises a biomass from a fermentation.

In other embodiments, the filler comprises an active filler (e.g., a filler capable of retaining the semiochemical).

In certain embodiments, a composition of the present disclosure comprises from about 1 wt % to about 98 wt % of a filler, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt %, including all values and ranges there between.

In other embodiments, the composition comprises from about 1 wt % to about 80 wt %, about 1 wt % to about 90 wt %, about 1 wt % to about 98 wt %, about 5 wt % to about 80 wt %, about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of a filler.

In some embodiments, the composition further comprises an additive, an antioxidant, a UV-blocking agent, an anticaking agent, or mixtures thereof.

In other embodiments, the composition further comprises an additive. In embodiments, the additive is a dye, reflectant, inorganic salt, organic salt, or mixtures thereof.

In certain embodiments, the composition further comprises an antioxidant. In embodiments, the antioxidant is butylated hydroxytoluene (BHT), tert-butylhydroquinone (TBHQ), and mixtures thereof.

In embodiments, a composition of the present disclosure comprises from about 0.1 wt % to about 1 wt % of an antioxidant, e.g., about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %, including all values and ranges there between.

In particular embodiments, the composition comprises about 0.1 wt % to about 0.5 wt %, about 0.2 wt % to about 0.5 wt %, about 0.3 wt % to about 0.5 wt %, about 0.1 wt % to about 1 wt %, about 0.2 wt % to about 1 wt %, about 0.3 wt % to about 1 wt %, about 0.4 wt % to about 1 wt %, about 0.5 wt % to about 1 wt %, about 0.6 wt % to about 1 wt %, about 0.7 wt % to about 1 wt % of an antioxidant.

In some embodiments, the composition comprises about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of an antioxidant.

In certain embodiments, the composition further comprises a UV-blocking agent. In embodiments, the UV-blocking agent is methyl cinnamate, iron oxides, carbon black, octabenzone, or mixtures thereof.

In other embodiments, the composition further comprises an anticaking agent. In embodiments, the anticaking agent is charcoal, amorphous silica, fumed silica, or mixtures thereof.

In particular embodiments, a composition of the present disclosure comprises from about 0 wt % to about 2 wt % of an anticaking agent, e.g., about 0 wt %, about 0.5 wt %, about 1 wt %, about 1.5 wt %, or about 2 wt %, including all values and ranges there between.

In other embodiments, the composition comprises about 0 wt % to about 0.5 wt %, about 0 wt % to about 1 wt %, about 0 wt % to about 1.5 wt %, about 0 wt % to about 2 wt %, about 0.5 wt % to about 1 wt %, about 0.5 wt % to about 1.5 wt %, about 0.5 wt % to about 2 wt %, about 1 wt % to about 1.5 wt %, about 1 wt % to about 2 wt %, or about 1.5 wt % to about 2 wt % of an anticaking agent.

In some embodiments, the composition comprises about 0 wt %, about 0.5 wt %, about 1 wt %, about 1.5 wt %, or about 2 wt % of an anticaking agent.

In certain embodiments, a composition of the present disclosure comprises from about 1 wt % to about 70 wt % of an active ingredient composition comprising one or more active ingredients, e.g., about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt %, including all values and ranges therebetween.

In particular embodiments, the composition comprises from about 1 wt % to about 70 wt %, about 1 wt % to about 50 wt %, about 10 wt % to about 60 wt %, about 15 wt % to about 70 wt %, about 20 wt % to about 60 wt %, about 25 wt % to about 70 wt %, about 30 wt % to about 50 wt %, about 50 wt % to about 70 wt % of an active ingredient composition.

In other embodiments, the composition comprises about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt % of an active ingredient composition. In embodiments, the active ingredient composition comprises from about 10 wt % to about 98 wt % of one or more active ingredients. In embodiments, the active ingredient composition comprises from about 10 wt % to about 20 wt %, about 20 wt % to about 40 wt %, about 20 wt % to about 80 wt %, about 30 wt % to about 50 wt %, about 30 wt % to about 70 wt %, about 40 wt % to about 80 wt %, about 40 wt % to about 90 wt %, about 50 wt % to about 70 wt %, about 50 wt % to about 80 wt %, about 50 wt % to about 90 wt %, about 60 wt % to about 80 wt %, about 60 wt % to about 90 wt %, about 70 wt % to about 90 wt %, about 80 wt % to about 90 wt %, about 80 wt % to about 98 wt %, about 90 wt % to about 98 wt % of one or more active ingredients. In embodiments, the active ingredient composition comprises about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 96 wt %, about 97 wt %, or about 98 wt % of one or more active ingredients.

In particular embodiments, a composition of the present disclosure comprises from about 1 mg to about 5 mg of an active ingredient composition. In embodiments, the composition comprises from about 1 mg to about 2 mg, about 1 mg to about 3 mg, about 1 mg to about 4 mg, about 1 mg to about 5 mg, about 2 mg to about 3 mg, about 2 mg to about 4 mg, about 2 mg to about 5 mg, about 3 mg to about 4 mg, about 3 mg to about 5 mg, or about 4 mg to about 5 mg of an active ingredient composition. In embodiments, the composition comprises about 1 mg, about 1.5 mg, about 2 mg, about 2.5 mg, about 3 mg, about 3.5 mg, about 4 mg, about 4.5 mg, or about 5 mg of an active ingredient composition.

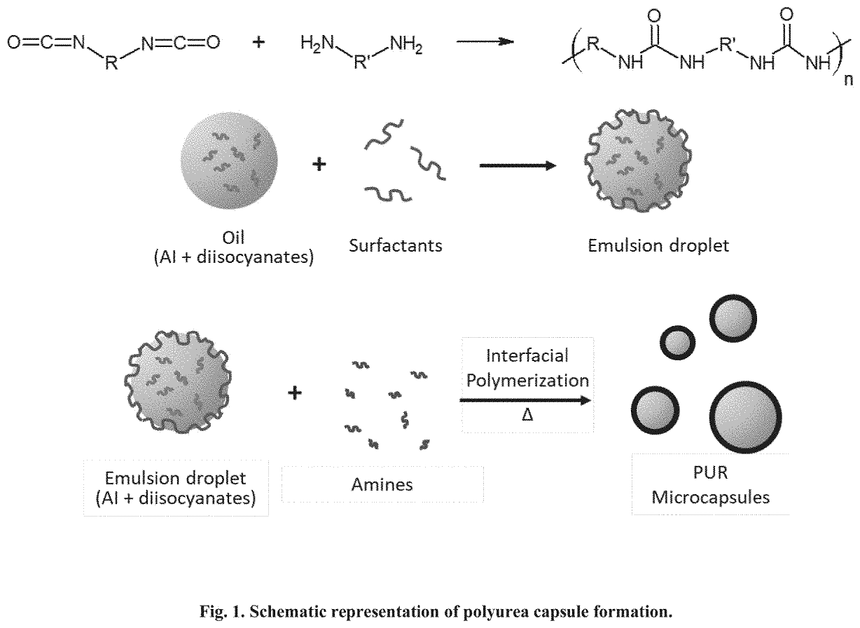

As shown in FIG. 1, polyurea (PUR) microcapsules are formed by the reaction between diisocyanates and multiamines that are dissolved in the oil phase and the aqueous phase, respectively. Since each reactant is dissolved in separate phase and polymerized at the interface between the two phases, this process is called interfacial polymerization. PUR chemistry is the most popular microencapsulation technology. The reaction is fast and capsule properties can be tuned by the amount and variation of diisocyanates and multiamines (R and R′ in the top of FIG. 1). The water phase may also include any suitable surfactant. The oil phase contains at least a sex pheromone and at least one type of diisocyanates. Diisocyanates are selected from 2,4-toluene diisocyanate (TDI), 4,4-diphenylmethane diisocyanate (MDI), isophorone diisocyanate (IPDI), and 1,6-hexamethylene diisocyanate (HDI). In some cases, the oil phase includes diluent oil such as paraffin oil, epoxidized soybean oil, or wax. The oil phase is emulsified using high speed stirrer in the aqueous phase with and at least an emulsifier such as polyvinylalcohol (PVA, 88-89% hydrolyzed) and lignin sulfonate. After emulsification, temperature is raised to the reaction temperature, and the multiamines are added in the water phase, resulting in the capsule wall formation by interfacial polymerization between diisocyanates in the oil phase and multiamine in the water phase. Multiamines are selected from ethylenediamine (EDA), hexanediamine (HDA), diethylenetriamine (DETA), and urea. Once the capsule wall formation is finished, other additives are mixed in, such as suspending agent (polyvinylpyrrolidone, PVP), viscosity modifier (Kelzan S), anti-freezer (propylene glycol), and biocides (Proxel GXL). The polyurea microcapsule formation process is summarized in FIG. 1.

### GENERAL PROCEDURES

In the particular embodiments described in the foregoing Examples, reactors used for the following procedures were setup in water baths set to 50° C. prior to the start of each of the listed examples. A large beaker was also preheated to 60° C. in an oven for each example. Kelzan S gel used for each example is prepared by mixing 2 wt % of Kelzan S and 1 wt % of Proxel GXL in a high shear mixer. The particle sizes of the resulting capsules were measured with a Horiba LA-350 particle size analyzer.

### Example 1

An oil phase solution of 392.7 g of Z9-14:OAc (95.5%), 77.7 g of Z11-16:OAc (72.3%), 45.0 g of Sunspray 6N, and 60.0 g of PAPI 27 (Polymeric MDI, DOW) was prepared and preheated in a 60° C. oven for 1 hour. In a glass beaker or receiving flask, an aqueous solution consisting of 60.0 g of Selvol 24-203 and 624.75 g of deionized water was prepared and placed in the 60° C. oven for one hour. The preheated aqueous solution was then transferred to a large, preheated beaker and placed under a high shear mixer and stirred at a low speed. The premade oil phase solution was then added to the aqueous phase, and the mixing speed was increased. The mixture was allowed to stir for three minutes. The resulting emulsion was then transferred to a reactor preheated to 50° C. with a mechanical overhead stirrer. In a separate container an amine solution was prepared with 7.5 g of ethylene diamine, 7.5 g of diethylene triamine and 45.0 g of water. The amine solution was then quickly added to reactor containing the emulsion at high mixing speed. After complete addition of the amine solution, the mixture was stirred at a low-speed setting for 1 hour at 50° C. After 1 hour of stirring, the water bath was turned off and 45 g of PVP K30 and 4.5 g of Reax 88B were added, and the resulting solution was stirred for 10 minutes. 37.5 g of the pre-made Kelzan S gel and 75 g of propylene glycol were then added, and the reaction was allowed to stir overnight.

### Example 2

An oil phase solution of 393.9 g of Z9-14AC (95.2%), 74.2 g of Z11-16AC (75.6%), and 15.0 g of PAPI 27 (Polymeric MDI, DOW) was prepared and preheated in an oven set to 60° C. In a glass beaker or receiving flask, an aqueous solution of 60.0 g of Selvol 24-203 and 720.0 g of deionized water was prepared and placed in the 60° C. oven for one hour. The preheated aqueous solution was then transferred to a large, preheated beaker and placed under a high shear mixer and stirred at a low speed. The premade oil phase solution was then added to the aqueous phase, and the mixing speed was increased. The mixture was allowed to stir for 3 minutes. The resulting emulsion was then transferred to a reactor preheated to 50° C. with a mechanical overhead stirrer. In a separate container an amine solution was prepared with 3.75 g of ethylene diamine, and 45.0 g of water. The amine solution was then quickly added to reactor containing the emulsion at high mixing speed. After complete addition of the amine solution, the mixture was stirred at a low-speed setting for 1 hour. The water bath was then turned off and 45 g of PVP K30 and 4.5 g of Reax 88B were added, and the resulting solution was stirred. 37.5 g of the pre-made Kelzan S gel and 101 g of deionized water were then added, and the reaction was allowed to stir overnight.

### Example 3

An oil phase solution of 393.9 g of Z9-14AC (95.2%), 74.2 g of Z11-16AC (75.6%), and 15.0 g of PAPI 27 (Polymeric MDI, DOW) was prepared and preheated in an oven set to 60° C. In a glass beaker or receiving flask, an aqueous solution of 60.0 g of Selvol 24-203 and 720.0 g of deionized water was prepared and placed in the 60° C. oven. The preheated aqueous solution was then transferred to a large, preheated beaker and placed under a high shear mixer and stirred at a low speed. The premade oil phase solution was then added to the aqueous phase, and the mixing speed was increased. The resulting emulsion was then transferred to a reactor preheated to 50° C. with a mechanical overhead stirrer. In a separate container an amine solution was prepared with 10.7 g of 1,6-hexanediamine, and 45.0 g of water. The amine solution was then quickly added to reactor containing the emulsion at high mixing speed. After complete addition of the amine solution, the mixture was stirred at a low-speed setting. The water bath was turned off and 45 g of PVP K30 and 4.5 g of Reax 88B were added, and the resulting solution was stirred. 37.5 g of the pre-made Kelzan S gel and 94.2 g of deionized water were then added, and the reaction was allowed to stir overnight.

### Example 4

An oil phase solution of 434.2 g of Z7-12AC (95.0%), 49.5 g of epoxidized soybean oil, and 82.5 g of PAPI 27 (Polymeric MDI, DOW), was prepared and preheated in an oven set to 60° C. In a glass beaker or receiving flask, an aqueous solution of 66.0 g of Selvol 24-203 and 728.2 g of deionized water was prepared and placed in the 60° C. oven for one hour. The preheated aqueous solution was then transferred to a large, preheated beaker and placed under a high shear mixer and stirred at a low speed. The premade oil phase solution was then added to the aqueous phase, and the mixing speed was increased. The resulting emulsion was then transferred to a reactor preheated to 50° C. with a mechanical overhead stirrer. In a separate container, an amine solution was prepared with 10.3 g of ethylene diamine, 10.3 g of diethylene triamine and 49.5 g of water. The amine solution was then quickly added to reactor containing the emulsion at high mixing speed. After complete addition of the amine solution, the mixture was stirred at a low-speed setting. The water bath was turned off and 49.5 g of PVP K30, 4.95 g of Reax 88B were added, and the resulting solution was stirred. 82.5 g of the pre-made Kelzan S gel and 94.2 g of deionized water, and the reaction was allowed to stir overnight.

### Example 5

An oil phase solution of 434.2 g of Z7-12AC (95.0%) and 49.5 g of PAPI 27 (Polymeric MDI, DOW) was prepared and preheated in an oven set to 60° C. In a glass beaker or receiving flask, an aqueous solution of 66.0 g of Selvol 24-203 and 769.4 g of deionized water was prepared and placed in the oven for one hour. The preheated aqueous solution was then transferred to a large, preheated beaker and placed under a high shear mixer and stirred at a low speed. The premade oil phase solution was then added to the aqueous phase, and the mixing speed was increased. The resulting emulsion was then transferred to a reactor preheated to 50° C. with a mechanical overhead stirrer. In a separate container an amine solution was prepared with 6.2 g of ethylene diamine, 6.2 g of diethylene triamine and 49.5 g of water. The amine solution was then quickly added to reactor containing the emulsion at high mixing speed. After complete addition of the amine solution, the mixture was stirred at a low-speed setting. The water bath was turned off and 49.5 g of PVP K30, 4.95 g of Reax 88B were added, and the resulting solution was stirred. 82.5 g of the pre-made Kelzan S gel and 132.1 g of deionized water, and the reaction was allowed to stir overnight.

### Example 6

An oil phase solution of with 434.2 g of Z7-12AC (95.0%) and 49.5 g of PAPI 27 (Polymeric MDI, DOW) was prepared and preheated in an oven set to 60° C. In a glass beaker or receiving flask, an aqueous solution of 66.0 g of Selvol 24-203 and 769.4 g of deionized water was prepared and placed in the 60° C. oven for one hour. The preheated aqueous solution was then transferred to a large, preheated beaker and placed under a high shear mixer and stirred at a low speed. The premade oil phase solution was then added to the aqueous phase, and the mixing speed was increased. The resulting emulsion was then transferred to a reactor preheated to 50° C. with a mechanical overhead stirrer. In a separate container, an amine solution was prepared with 31.82 g of 1,6-hexanediamine, and 49.5 g of water. The amine solution was then quickly added to reactor containing the emulsion at high mixing speed. After complete addition of the amine solution, the mixture was stirred at a low-speed setting. The water bath was turned off and 49.5 g of PVP K30, 4.95 g of Reax 88B were added, and the resulting solution was stirred. 82.5 g of the pre-made Kelzan S gel and 112.6 g of deionized water, and the reaction was allowed to stir overnight.

### Example 7

The particle size of each formulation is measured using Horiba particle sizer LA-350. The refractive index of particle is set to be 1.53 and that of water is set to be 1.33. Table 1 shows their median particle sizes (D50).

TABLE 1
Median particle size
of Examples 1-6

| | Median particle |
|---|---|
| Sample | size (D50) |
| Examples 1 | 4.40 |
| Examples 2 | 3.45 |
| Examples 3 | 3.47 |
| Examples 4 | 3.72 |
| Examples 5 | 10.01 |
| Examples 6 | 10.01 |

### Example 8—Active Ingredient (AI) Release Rate

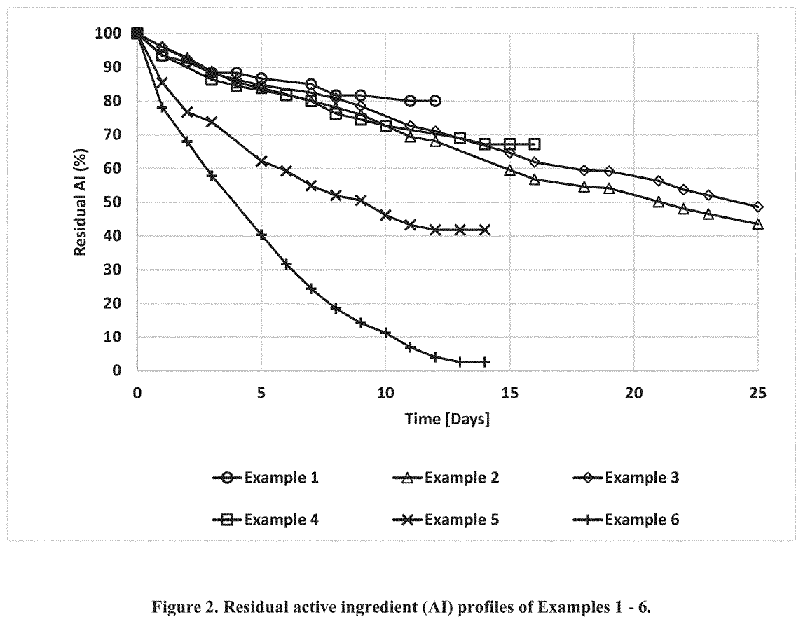

The samples are aged in a 40° C. oven and the weight changes are monitored in time. Residual AI is calculated based on the initial amount. Residual AI profiles of the formulations from Examples 1 through 6 are shown in FIG. 2.

Several aspects of the invention can be varied or altered, including by way of example, one or more of the following:
1. The fraction of polyurea in the total formulation can be varied from 0.5% to 7.0%;
2. Diisocyanates can be at least one compound from the group of 2,4-toluene diisocyanate (TDI),
4,4-diphenylmethane diisocyanate (MDI), Polymeric MDI, isophorone diisocyanate (IPDI), and
1,6-hexamethylene diisocyanate (HDI);
3. Multiamines can be at least one compound from the group of ethylenediamine (EDA), hexanediamine (HDA), diethylenetriamine (DETA), and urea;
4. The fraction of emulsifier in the total formulation can be adjusted from 0.1% to 3.0%;
5. The oil phase can be changed depending on the insect species targeted. (E.g. Z7-12:OAc for soybean looper or Z11-16:OAc+Z9-14:OAc for fall army worm);
6. The emulsifier can be either polyvinyl alcohol (PVA) or sodium lignosulfonate (Reax 88b);
7. The shear rate for emulsification can be varied from 4000-10000 rpm;
8. The shear time for emulsification can be varied from 4000-10000 rpm;
8. The shear time for emulsification can be varied from 4-10 min; and
9. The particle size (D50) of the microcapsules can in the range of 2-20 microns.

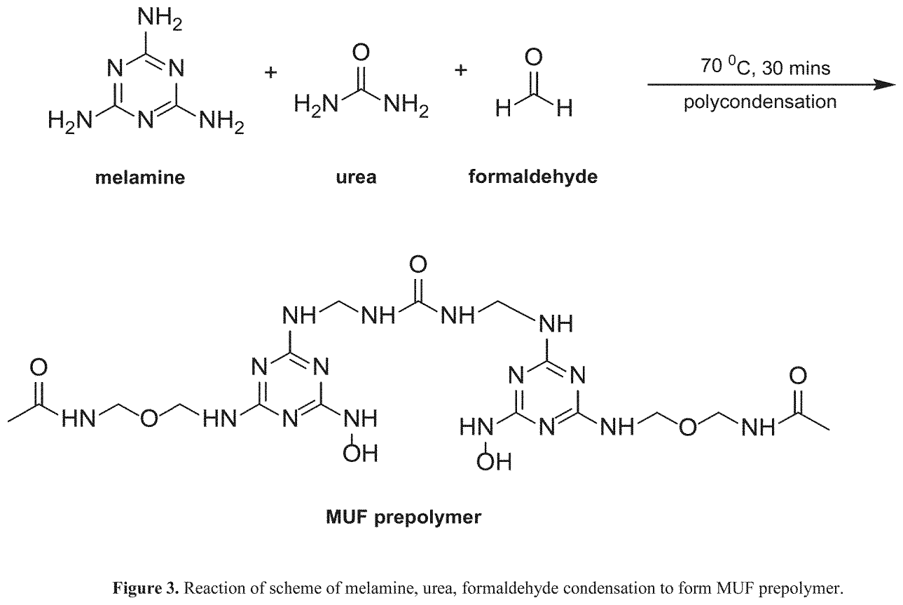

In another aspect of the invention, the process is generally carried out using a two-step in situ polymerization process. In the first step an aqueous formaldehyde solution is pH adjusted using triethanol amine (or any trisubstituted unreactive amine) to pH ˜ 9. The basic formaldehyde solution is then mixed with solid melamine and urea at the room temperature (rt). The resulting solution is then heated to induce a condensation reaction forming the melamine-urea-formaldehyde (MUF) prepolymer (see FIG. 3.) The prepolymer reaction is then quenched by adding room-temperature deionized water to the solution.

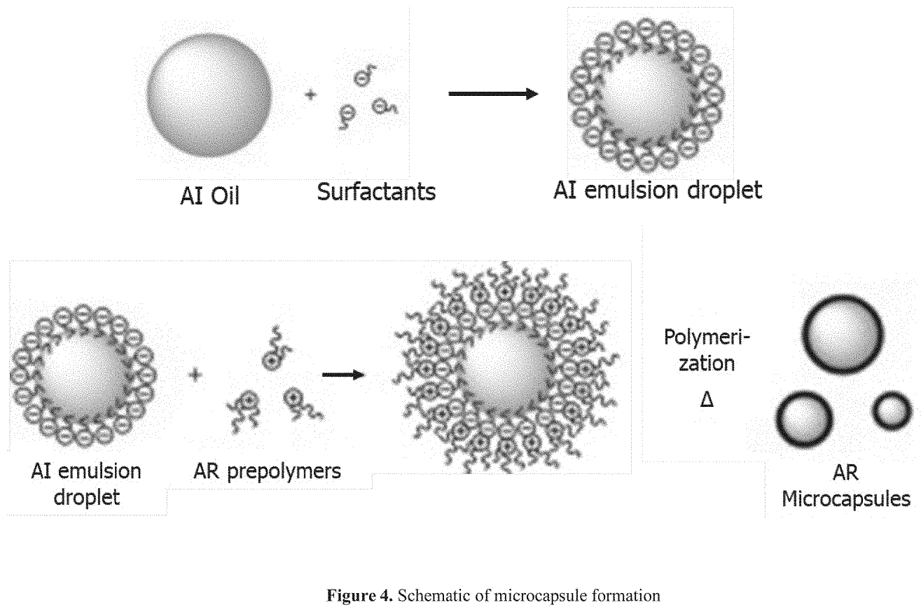

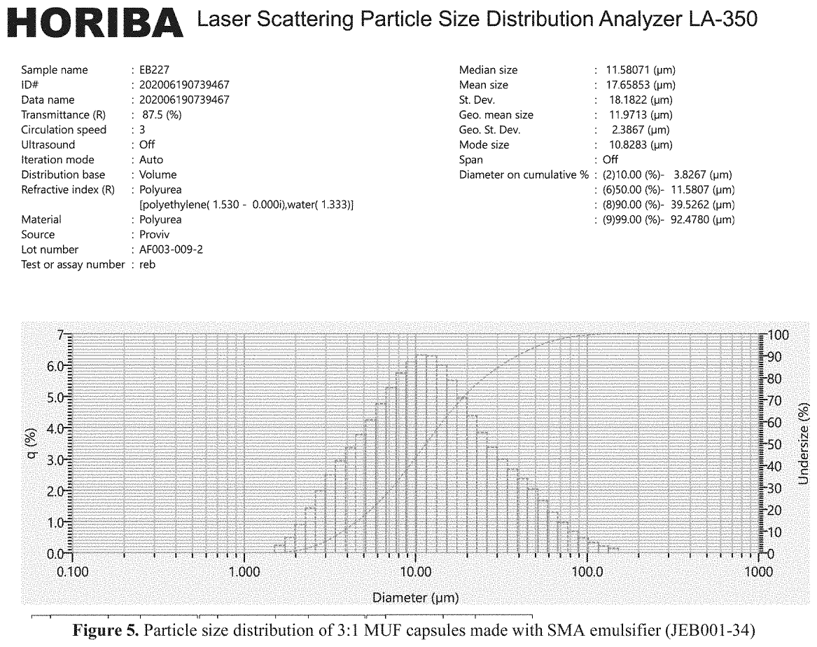

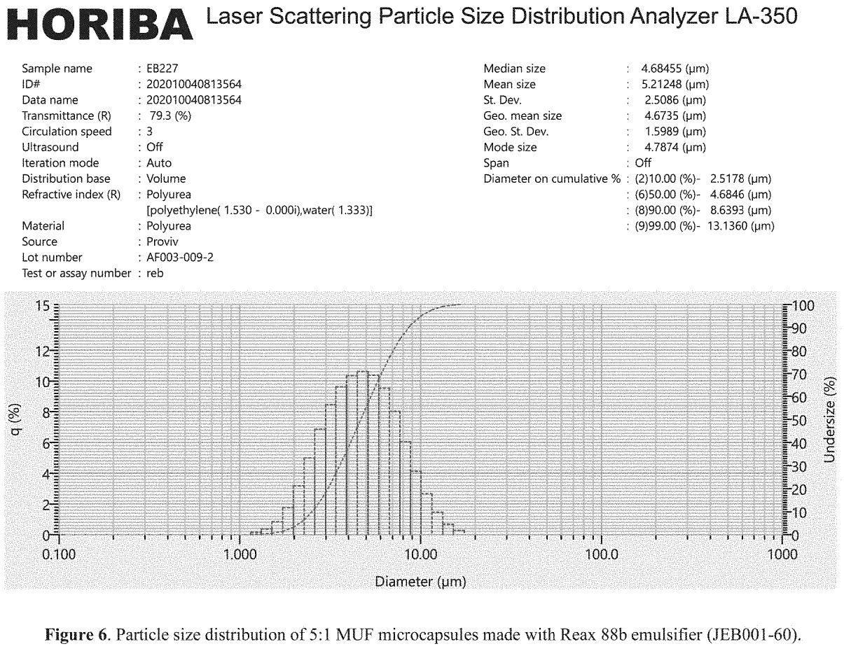

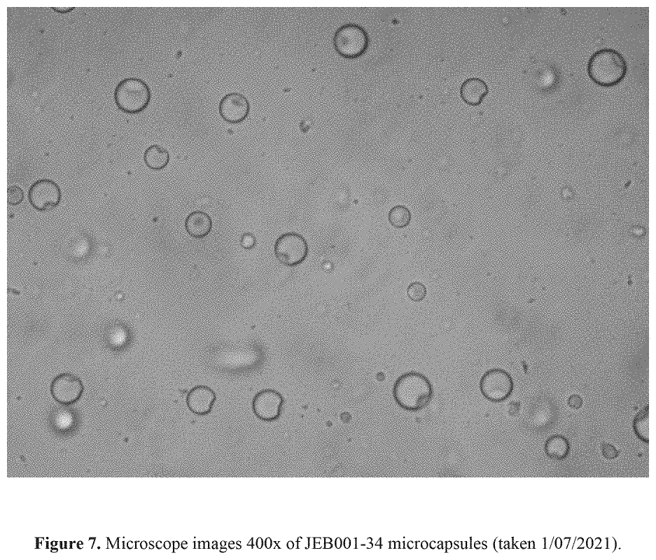

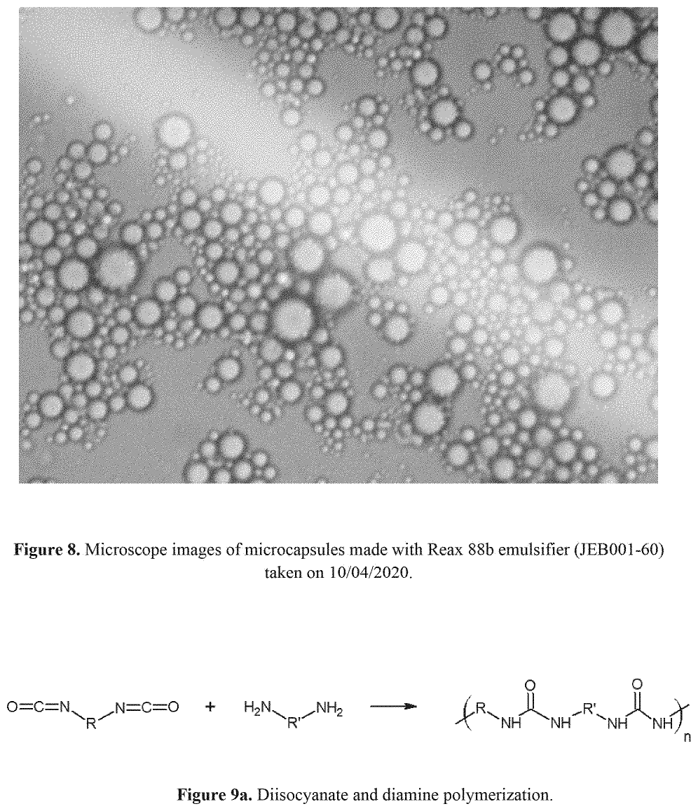

In the second step the core material (Z7-12:OAc, Z9-14:OAc+Z11-16:OAc, or any AI) is emulsified in an aqueous solution of an anionic protective colloid (either sodium lignosulfonate (Reax 88b) or styrene-maleic anhydride (SMA). The particle size of this emulsion can be adjusted by increasing the rotational speed of the high-sheer stirrer or increasing stirring times. The microcapsules are formed by the dropwise addition of the cationic prepolymer solution to the anionic emulsion solution, which results in a layer of MUF prepolymer bonded to the AI emulsion droplets ionically. The shell of the microcapsules is then cured by raising the temperature of the reaction (See FIG. 4). At the end of this curing stage, Reax 88b, polyvinylpyrrolidone (PVP-K30), and Kelzan S are added to the reaction mixture as stabilizers, urea is added to scavenge any remaining unreacted formaldehyde. The reaction was then stirred overnight, and particle size was measured using a Horiba Laser Scattering Particle Size Distribution Analyzer LA-350 (See FIGS. 5 and 6). Microscope images of the microcapsules were taken with a generic bench top microscope at 10× and 40× magnification (See FIGS. 7 and 8).

A sample procedure of the MUF microcapsule synthesis is as follows:

JB001-60 (MUF = 4, 5:1 M/U, Reax 88b Emulsifier, 200 g scale)

| Chemical | CAS | MW [g/mol] | Wt [g] | mol % | functionality | |
|---|---|---|---|---|---|---|
| Formaldehyde, | 50-00-0 | 30.03 | 8.8 | 5.46 | 5.46 | 2.6667 |
| 37 w % | | | | | | |
| Melamine | 108-78-1 | 126.12 | 4.4 | 1.71 | 5.12 | 3 |
| Urea | 57-13-6 | 60.06 | 0.4 | 0.34 | 0.34 | 1 |
| water | | | 16.4 | | | |
| triethanolamine | 102-71-6 | 149.19 | 0.72 | | | |
| Z9-14:OAc | | 254.4 | 52.5 | | | |
| Z11-16:OAC | | 282.5 | 9.9 | | | |
| TBHQ | 88-58-4 | 222.32 | 0.30 | | | |
| Reax 88b | | 13 % wt/vol | 2.9 | | | |
| water | | | 19.3 | | | |
| Citric acid 37 w % | 77-92-9 | 192.12 | 1.25-1.3 mL | | | |
| water | | | 68.8 | | | |
| Kelzan S solution | | | 10 | | | |
| (2 w % gel with | | | | | | |
| 1 w % Proxel | | | | | | |
| GXL) | | | | | | |
| FormaGo or Urea | | | 0,200 | | | |
| PVP K30 | | | 6.0 | | | |
| REAX 88B | | | 0.6 | | | |

### Example 9

Part 1: To a 2-neck round 100 mL bottom flask charged with a magnetic stir bar was added formaldehyde solution (8.8 g, Sigma Aldrich) and triethanolamine (0.72 g, Sigma Aldrich) was added dropwise. The resulting mixture was swirled until a homogenous mixture formed. A pre-weighed mixture of urea (0.4 g, Aldrich) and melamine (4.4 g, Aldrich) was then added to the formaldehyde solution and the round bottom flask was capped with a rubber septum and a thermometer/thermometer adapter. The flask was then placed in an oil bath set to 70° C. and heated. The reaction was quenched with water (16.4 mL) and the reaction temperature was lowered to 60° C. The reaction was then removed from the bath and cooled at room temperature prior to addition to the next steps.

Part 2: To a tared 100 mL bottle was added 52.5 g of Z9-14:OAc (95.5), 9.89 g of Z11-16:OAc (72.3), and 0.3 g of TBHQ. The resulting mixture was swirled until the TBHQ was incorporated into the mixture.

Part 3: To a tared 250 mL beaker was added 2.95 g Reax 88b and 19.3 mL of water. The mixture was swirled carefully until a homogenous solution was formed. To the Reax 88b solution was then added 68.8 mL of water and 1.25 mL of 37% citric acid solution. The resulting solution was stirred with the pH meter to ensure adequate mixture of all components.

The acidic Reax 88b solution was then agitated with the high sheer mixer and the pheromone solution (Oil phase) from part 2 was added slowly. Once the oil phase was completely added, the agitation was increased, and the emulsion was allowed to stir until completely homogenized.

Part 4: The resulting emulsion from part 3 was then transferred to a three neck round bottom flask, charged with an overhead stirrer and stirred. The prepolymer solution from part 1 was then added to dropwise to the emulsion. After the addition of the prepolymer solution, the temperature was increased to 70° C., and the stirring was increased. The reactant was stirred for three hours at 70° C. At three hours, a mixture of urea (200 mg), Reax 88b (600 mg) and PVP K30 (6 g) was added, and the reaction was cooled to room temperature. A solution of Kelzan S (10 g) was then added to the flask and the resulting suspension was stirred overnight. The particle size of the microcapsules was again measured the next morning, and microscope images were taken.

Several aspects of the invention can be varied or altered, including by way of example, one or more of the following:
1. The ratio of melamine to urea can be altered from 9:1 to 2:1 in the prepolymer synthesis step;
2. The ratio of emulsifier to AI can be adjusted from 1:20 to 1:25;
3. The ratio of shell material (MUF prepolymer) to AI can be adjusted from 1:4.5 to 1:12.5;
4. The AI/oil phase can be changed depending on the insect species targeted. (E.g. Z7-12:OAc for soybean looper or Z11-16:OAc+Z9-14:OAc for fall army worm);
5. The emulsifier can be either styrene maleic anhydride (SMA) or preferably sodium lignosulfonate;
6. The sheer rate for emulsification can vary from 4000-6000 rpm;
7. The sheer time for emulsification can vary from 4-6 min;
8. The particle size (d50) of the microcapsules can vary from 5-20 microns, preferably around 10 microns; and
9. Heating time for curing can vary from 3-8 hours and heating temperature for curing can vary from 60° C. to 80° C.

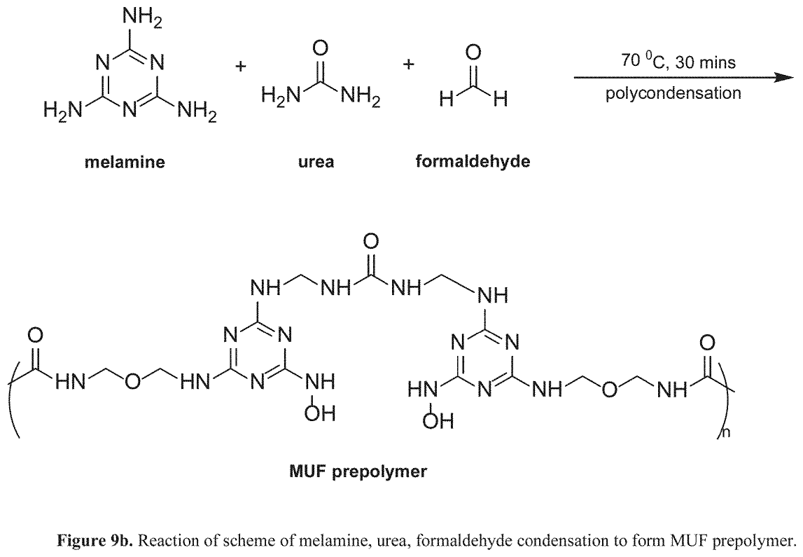

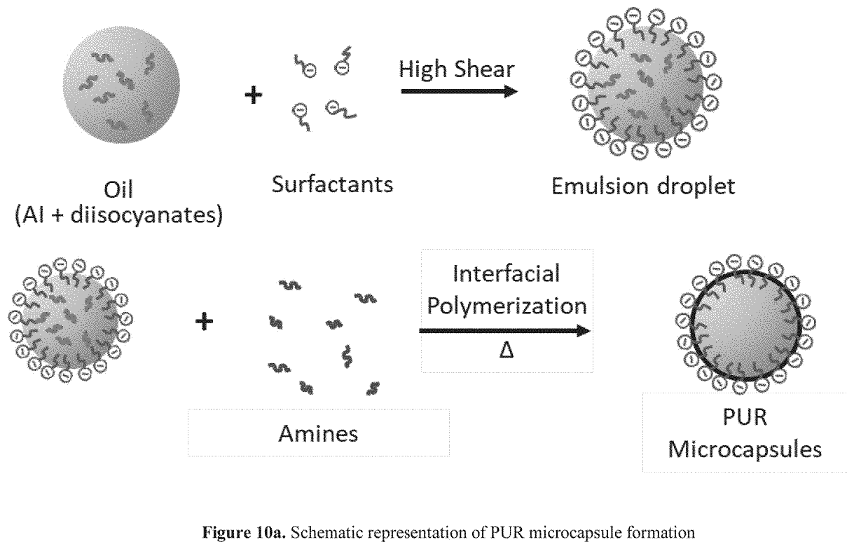

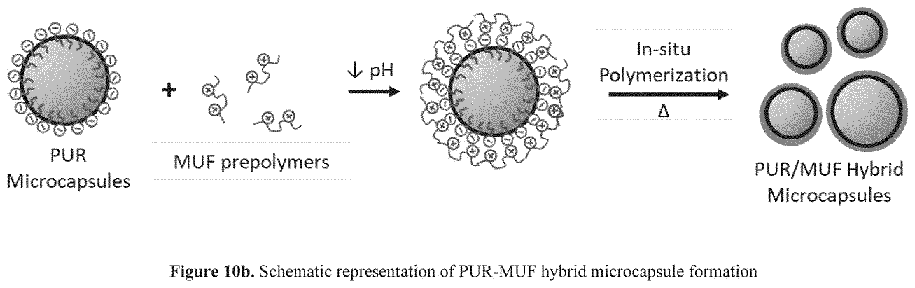

The process of the invention is generally carried out using a multistep reaction. In the first step a thin polyurea (PUR) microcapsule is formed by the reaction between diisocyanates and multiamines in a process called interfacial polymerization. In this process a low concentration of diisocyanates (0.25% -2.0%) are dissolved in the oil phase which contains at least one insect sex pheromone. The oil phase is then emulsified using a high shear mixer with an aqueous solution of sodium lignosulfonate, styrene-maleic-anhydride, or any suitable emulsifier. The resulting solution is then heated to the reaction temperature and an aqueous solution of multiamines (e.g., diethylene triamine, ethelyene diamine, urea, or hexanediamine) is added quickly to the reaction. The addition of the multiamine results in capsule wall formation by the interfacial polymerization between the diisocyantes in the oil phase and the amines in the aqueous phase (see FIG. 9a). The polymerization reaction is quickly completed forming polyurea microcapsules with a thin wall (see FIG. 10a).

In the second step the secondary MUF shell is formed on the outside of the thin PUR shell. This shell is formed using a two-step in situ polymerization process. In this step, in a separate reaction vessel, an aqueous formaldehyde solution is pH adjusted using triethanolamine (or any trisubstituted unreactive amine) to pH ˜ 9. The basic formaldehyde solution is then mixed with melamine and urea at room temperature. The resulting solution is then heated to ˜70 C to induce a condensation reaction forming the cationic melamine-urea-formaldehyde (MUF) prepolymer (see FIG. 9b) The prepolymer reaction is then quenched by adding room-temperature deionized water to the solution.

The resulting prepolymer solution is then added slowly to the PUR capsule solution prepared in step one. The MUF shell is formed by the addition of the cationic prepolymer to the anionic emulsifier solution surrounding the thin PUR capsules formed in step one, which results in a thin layer of MUF prepolymer ionically bonded to the anionic colloid surrounding the PUR capsules. The MUF shell of the microcapsules is then cured (See FIG. 10b). At the end of this curing stage, reax 88b, polyvinylpyrrolidone (PVP-K30), and Kelzan S are added to the reaction mixture as stabilizers, urea is added to scavenge any remaining unreacted formaldehyde. The reaction was then stirred overnight, and particle size was measured using a Horiba Laser Scattering Particle Size Distribution Analyzer LA-350. Microscope images of the microcapsules were taken with a generic bench top microscope at 10× and 40× magnification.

### Example 10

Part 1: To a blend of Z-9-tetradecenyl acetate (52.5 g, 95%) and Z-11-hexadecenyl acetate (9.89 g, 75%) was added PAPI-27 (polymethylene polyphenylisocyanate, 0.56 g, Dow industries) and the resulting oil phase was mixed until homogenous. In a separate container, Reax 88b (sodium lignosulfonate, 2.5 g) was dissolved in 60 mL of deionized water and stirred with a high shear mixer. While stirring, the PAPI-27 oil solution was slowly added, and the resulting mixture was stirred until a homogenous mixture was formed. The resulting emulsion containing AI and diisocyanate (PAPI-27) was then transferred to a reactor with a mechanical stirrer, heated to 50° C., and stirred. An amine solution was made by dissolving diethylenetriamine (0.23 g, Aldrich) in deionized water (10 g). The amine solution was quickly added to the reactor, and the reaction mixture was stirred. After the reaction was completed, citric acid (37% aq solution, 1.3 mL) was added to the reactor containing the PUR microcapsule suspension until a pH of 5.1-5.5 was reached and the temperature was maintained at 50° C.

Part 2: To a 2-neck round 100 mL bottom flask charged with a magnetic stir bar was added formaldehyde solution (2.2 g) and triethanolamine (0.16 g) was added dropwise. The resulting mixture was swirled until a homogenous mixture formed. A pre-weighed mixture of urea (0.1 g) and melamine (1.08 g) was then added to the formaldehyde solution and the round bottom flask was capped with a rubber septum and heated for 25 min at 70° C. The reaction was quenched with water (20.0 mL) and then removed from the bath and cooled at room temperature.

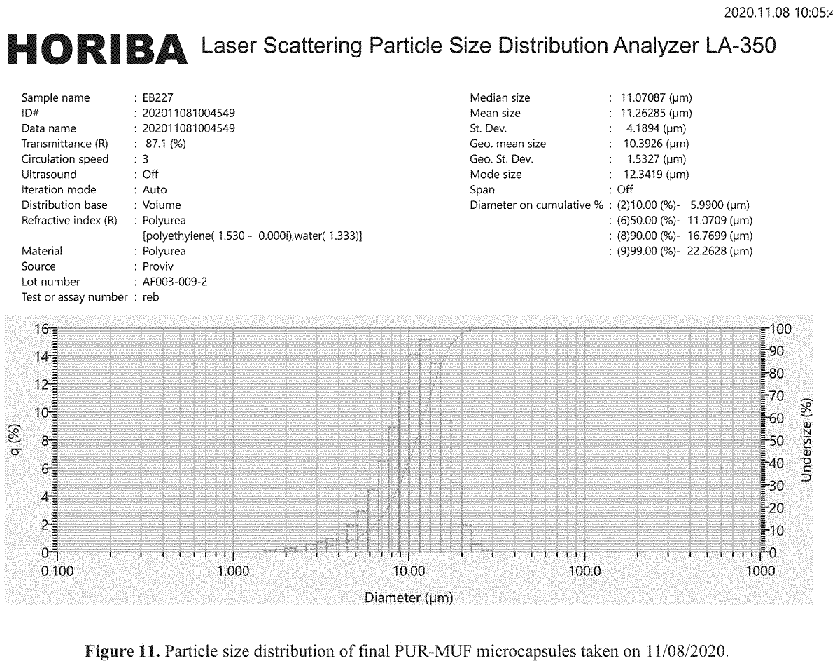

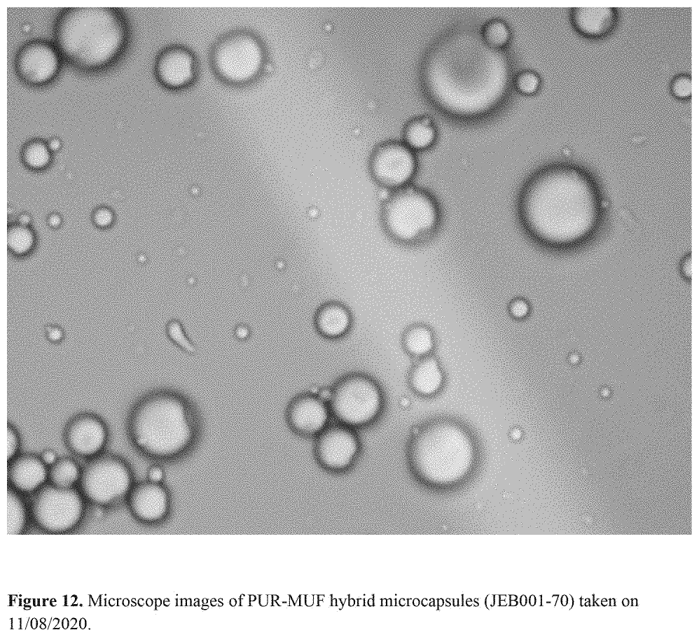

Part 3: The MUF prepolymer solution was added dropwise to the reactor containing the PUR microcapsule solution. The resulting mixture was stirred and the particle size of the resulting capsules were checked hourly to ensure that capsule size was consistent throughout the preparation process. At 4.5 hours, a mixture of urea (200 mg), reax 88b (600 mg) and PVP K30 (6 g) was added, and the reaction was cooled to rt. A solution of Kelzan S (10 g) was added to the flask and the resulting solution was stirred overnight. The particle size of the microcapsules was again measured the next morning, and microscope images were taken (see FIGS. 11 and 12).

Several aspects of the invention can be varied or altered, including by way of example, one or more of the following:
1. The % of diisocyanates and multiamines in the total reaction can be changed from 0.25% to
2.0% and still form viable capsules;
2. The ratio of melamine to urea can be altered from 9:1 to 2:1 in the prepolymer synthesis step;
3. The ratio of emulsifier to AI can be adjusted from 1:20 to 1:25;
4. The ratio of shell material (MUF prepolymer) to AI can be adjusted from 1:4.5 to 1:12.5;
5. The AI/oil phase can be changed depending on the insect species targeted. (E.g. Z7-12:OAc for soybean looper or Z11-16:OAc+Z9-14:OAc for fall army worm);
6. The emulsifier can be either styrene maleic anhydride (SMA) or preferably sodium lignosulfonate (Reax 88b);
7. The shear rate for emulsification can vary from 4000-6000 rpm;
8. The shear time for emulsification can vary from 4-6 min;
9. The particle size (d50) of the microcapsules can vary from 5-20 microns, preferably around 10 microns;
10. Heating time for curing can vary from 3-8 hours and heating temperature for curing can vary from 60° C. to 80° C.;
11. Diisocyanates can be at least one compound from the group of 2,4-toluene diisocyanate (TDI), 4,4-diphenylmethane diisocyanate (MDI), Polymeric MDI, isophorone diisocyanate (IPDI), and 1,6-hexamethylene diisocyanate (HDI); and
12. Multiamines can be at least one compound from the group of ethylenediamine (EDA), hexanediamine (HDA), diethylenetriamine (DETA), and urea.

### Example 11

### Aldehyde Microcapsules

In this aspect of the invention, the technology described in group 2 is utilized to microencapsulate aliphatic aldehyde pheromones, such as (Z)-11-hexadecenal, (Z)-9-hexadecenal, (Z)-11-octadecenal and (Z)-13-octadecenal. The two step in-situ polymerization reaction is carried out in the same way as described above, however hydrophobic surfactant with decreased sulfonation (e.g., HYACT, Reax 907, Reax 905, Polyfon-O) are used to increase the stability of the aliphatic aldehyde emulsions, allowing for the encapsulation of these pheromones with melamine-urea-formaldehyde polymer shells.

Part 1: To a 2-neck round 100 mL bottom flask charged with a magnetic stir bar was added formaldehyde solution (8.8 g, Sigma Aldrich) and triethanolamine (0.72 g, Sigma Aldrich) was added dropwise. The resulting mixture was swirled until a homogenous mixture formed. A pre-weighed mixture of urea (0.4 g, Aldrich) and melamine (4.4 g, Aldrich) was then added to the formaldehyde solution and the round bottom flask was capped with a rubber septum and a thermometer/thermometer adapter. The flask was then placed in an oil bath set to 70° C. and heated. The reaction was quenched with water (16.4 mL) and the reaction temperature was lowered to 60° C. The reaction was then removed from the bath and cooled at room temperature prior to addition to the next steps.

Part 2: To a tared 100 mL bottle was added (Z)-9-hexadecenal (52.85 g, 96%), which was set aside to be used in part 3.

Part 3: To a tared 250 mL beaker was added Polyfon-O (sodium lignosulfonate, 2.5 g) and 60 mL of deionized water. The resulting mixture was stirred until all the Polyfon-O emulsifier was dissolved. The solution was then agitated with a high sheer mixer, and the (Z)-9-hexadecenal (52.85 g, oil phase) was added slowly. Once the oil phase was completely added, the agitation was increased until a stable emulsion was formed. To this emulsion was added citric acid solution (0.5 mL, 37% wt/wt) and the pH of acidified emulsion was monitored with a portable pH meter.

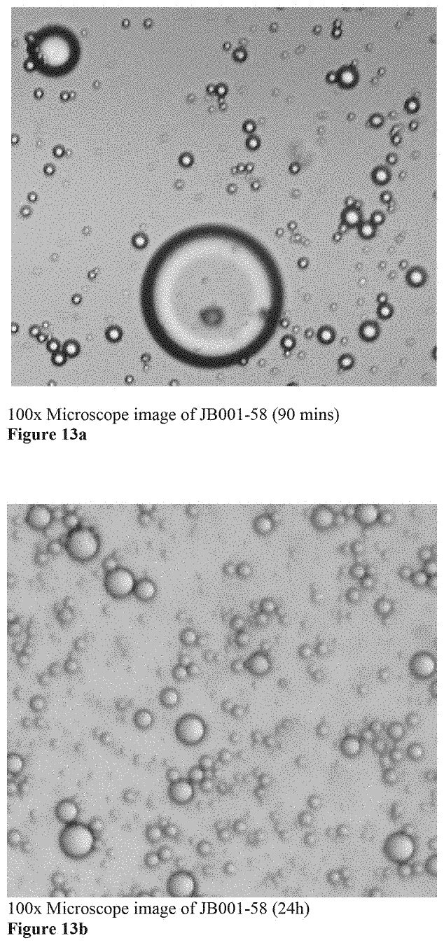

Part 4: The resulting emulsion from part 3 was then transferred to a three neck round bottom flask, charged with an overhead stirrer and stirred. The prepolymer solution from part 1 was then added to dropwise to the emulsion. After the addition of the prepolymer solution, the temperature was increased to 75° C., and the stirring was increased. The reactant was stirred for three hours at 75° C. At three hours, a mixture of urea (200 mg), Reax 88b (600 mg) and PVP K30 (6 g) was added, and the reaction was cooled to room temperature. A solution of Kelzan S (10 g) was then added to the flask and the resulting suspension was stirred overnight. The particle size of the microcapsules was again measured the next morning, and microscope images were taken (FIGS. 13a and 13b).

### Example 12

Part 1: To a 2-neck round 100 mL bottom flask charged with a magnetic stir bar was added formaldehyde solution (8.8 g, Sigma Aldrich) and triethanolamine (0.72 g, Sigma Aldrich) was added dropwise. The resulting mixture was swirled until a homogenous mixture formed. A pre-weighed mixture of urea (0.4 g, Aldrich) and melamine (4.4 g, Aldrich) was then added to the formaldehyde solution and the round bottom flask was capped with a rubber septum and a thermometer/thermometer adapter. The flask was then placed in an oil bath set to 70° C. and heated. The reaction was quenched with water (16.4 mL) and the reaction temperature was lowered to 60° C. The reaction was then removed from the bath and cooled at room temperature prior to addition to the next steps.

Part 2: To a tared 100 mL bottle was added (Z)-9-hexadecenal (52.85 g, 96%), which was set aside to be used in part 3.

Part 3: To a tared 250 mL beaker was added Reax 907 (sodium lignosulfonate, 2.5 g) and 60 mL of deionized water. The resulting mixture was stirred until all the Polyfon-O emulsifier was dissolved. The solution was then agitated with a high sheer mixer, and the (Z)-9-hexadecenal (52.85 g, oil phase) was added slowly. Once the oil phase was completely added, the agitation was increased until a stable emulsion was formed. To this emulsion was added citric acid solution (0.15 mL, 37% wt/wt) and the pH of acidified emulsion was monitored with a portable pH meter.

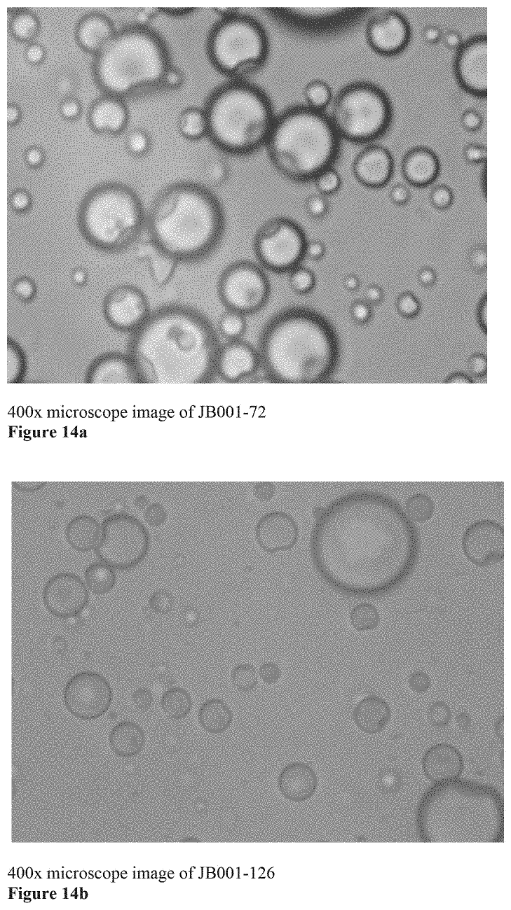

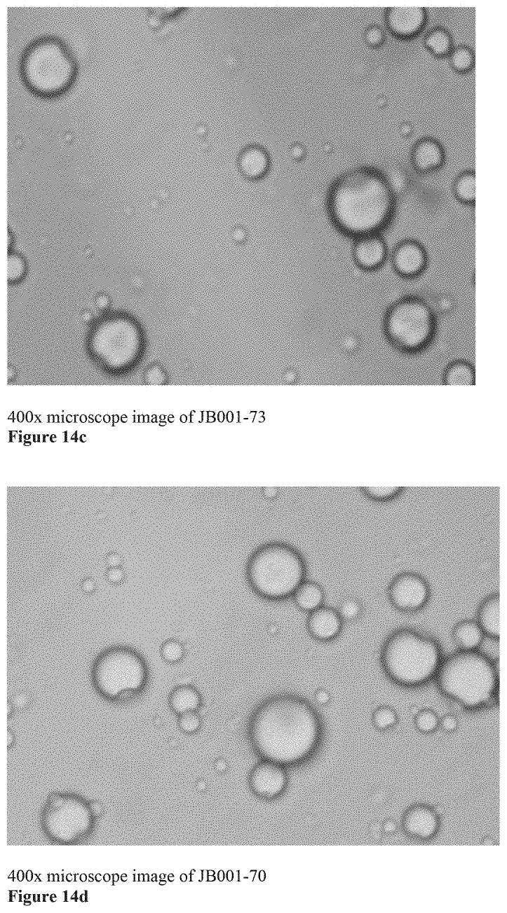

Part 4: The resulting emulsion from part 3 was then transferred to a three neck round bottom flask, charged with an overhead stirrer and stirred. The prepolymer solution from part 1 was then added to dropwise to the emulsion. After the addition of the prepolymer solution, the temperature was increased to 75° C., and the stirring was increased. The reactant was stirred for three hours at 75° C. At three hours, a mixture of urea (200 mg), Reax 88b (600 mg) and PVP K30 (6 g) was added, and the reaction was cooled to room temperature. A solution of Kelzan S (10 g) was then added to the flask and the resulting suspension was stirred overnight. The particle size of the microcapsules was again measured the next morning, and microscope images were taken (FIGS. 13b and 14b).

TABLE 2
Characteristics of aliphatic aldehyde MUF microcapsules.

| Sample | | | | | Capsule | |
|---|---|---|---|---|---|---|
| Name | Surfactant | MUF % | M/U | Dimples | Characteristics | EE % |
| JB001-154 | Reax 88b | 5 | 9 | No | Smooth surface, aggregates | 87.0% |
| JB001-155 | Reax88b | 4 | 9 | No | Rough surface, no aggregates | 69.4% |
| JB002-07 | HYACT | 5 | 9 | Yes | Smooth surface, aggregates | 94.8% |
| JB002-08 | Polyfon-O | 5 | 9 | Yes | Smooth surface, aggregates | 98.7% |
| JB002-09 | Reax907 | 5 | 9 | Yes | Smooth surface, aggregates | 92.4% |
| JB002-15 | Reax907 | 5 | 9 | Yes | Smooth surface, aggregates | 79.7% |

### Microcapsule Stability

### Example 13

After synthesis of the MUF microcapsule, stability testing was conducted. The MUF microcapsules demonstrated issues with capsule coalescence. Specifically, during synthesis, the MUF microcapsules combined to form larger capsules after 90 minutes and then shrunk back down to normal size after 24 hours. (See FIGS. 13a and 13b). This results in weak capsule walls and low encapsulation efficiency, as shown in Table 2, which affects capsule performance. Capsules lacking dimples are indicative of well-made capsules.

TABLE 3

| | Total | Encapsulated | Encapsulation |
|---|---|---|---|
| Sample | AI | AI | Efficiency |
| AF002-42 (AR, Corn) | 28.3% | 1.1% | 4% |
| AF002-44 (AR, Corn) | 25.3% | 8.0% | 32% |
| AF002-52 (AR, Soy) | 24.5% | 0.6% | 2% |
| JB001-59 (AR, Corn) | 28.9% | 6.3% | 22% |
| JB001-60 (AR, Corn) | 28.7% | 2.4% | 8% |

### Example 14

After synthesis of the PUR-MUF microcapsule, stability testing was conducted. To stabilize the synthesis of MUF microcapsules and combine the unique properties of polyurea and amino resin capsules, as previously described, a composite capsule containing a dual wall was synthesized. Synthesis of composite PUR-MUF microcapsules combines interfacial polymerization to produce a thin PUR shell, and in situ polymerization to produce a thicker MUF external shell. Presence of thin PUR shell should prevent coalescence issue. The synthesized PUR-MUF microcapsules were found to have favorable particle size stability and high encapsulation efficiency. (See FIGS. 14a-d and Tables 4 and 5).

TABLE 4

| | Emulsion | 2 hour | Final |
|---|---|---|---|
| | Particle | Particle | Particle |
| | Size D50 | Size D50 | Size D50 |
| Sample | (μm) | (μm) | (μm) |
| JB001-70 (MUF4, 0.5% PUR) | 10.23 | 11.85 | 11.07 |
| JB001-72 (MUF 2, 0.5% PUR) | 13.25 | 14.22 | 14.19 |
| JB001-73 (MUF 1, 0.5% PUR) | 9.7 | 10.24 | 10.4 |
| JB001-78 (MUF 1, 0.5% PUR) | 9.61 | 10.29 | 9.93 |
| JB001-79 (MUF 1, 0.25% PUR) | 9.51 | 9.88 | 10.14 |
| JB001-80 (MUF 1, 0.4% PUR) | 10.55 | 10.24 | 10.57 |
| JB001-87 (MUF 2, 0.25% PUR) | 9.33 | 9.76 | 9.63 |

TABLE 5

| | Total | Encapsulated | Encapsulation |
|---|---|---|---|
| Sample | AI | AI | Efficiency |
| JB001-70 (PUR/AR, Corn) | 23.2% | 23.1% | 99% |
| JB001-72 (PUR/AR, Corn) | 30.5% | 29.9% | 98% |
| JB001-73 (PUR/AR, Corn) | 29.4% | 29.1% | 99% |
| JB001-78 (PUR/AR, Corn) | 25.6% | 25.5% | 99% |
| JB001-79 (PUR/AR, Corn) | 25.0% | 25.8% | 103% |
| JB001-80 (PUR/AR, Corn) | 22.2% | 22.1% | 99% |
| JB001-87 (PUR/AR, Soy) | 20.1% | 20.0% | 99% |
| JB001-95 (PUR/AR, Soy) | 20.1% | 20.1% | 97% |

### Residual Active Ingredient (AI) Analysis

Residual AI kinetics assays were conducted to measure the total AI contained in sprayable microencapsulated formulations sprayed on a parchment paper substrate over several time points. This allows for in-lab screening of sprayable formulation performance. Various formulations were diluted (5×) and about 500 mg of the diluted formulation was sprayed on a 13×8 parchment paper sheet. The sheets were then aged in an environmental chamber (40° C. and 50% RH) and a total AI was analyzed over a 15-day period. Samples were collected and analyzed for total AI on days 0, 3, 7, 11, and 15 (3 replicates per day). The ratio of AI components was also measured over the 15-day bioassay interval.

### Example 15

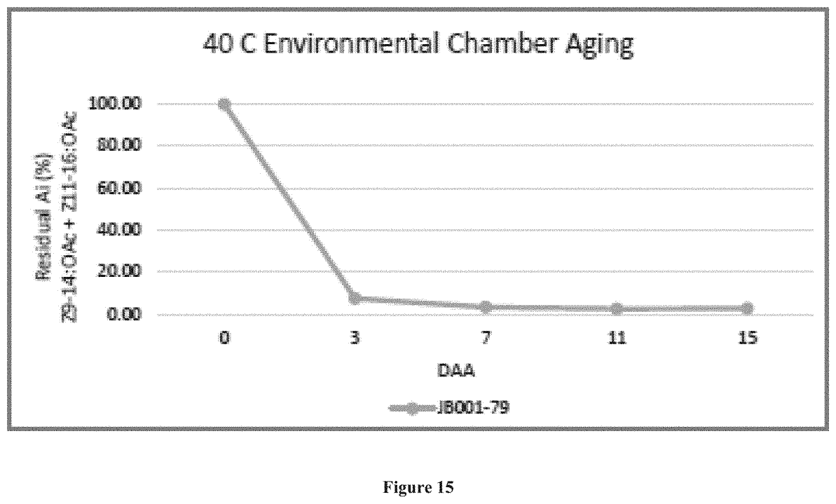

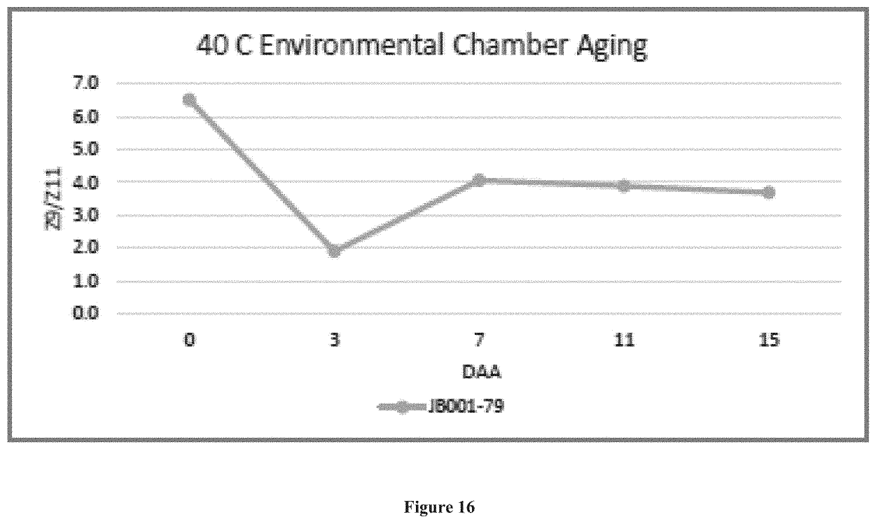

Initial residual AI tests of thin wall (MUF 1%, 0.25%) PUR-MUF microcapsules showed loss of 95% of AI within 3 days. (See FIG. 15). The ratio of Z9-14:OAc to Z11-16:Oac varied from 6.5 to 1.9 after 3 days of release, then stabilized to 4.0 to 3.8 from day 7-14. (See FIG. 16). Samples with various ratios of PUR and MUF and melamine/urea ratios ([M]/[U]) were also analyzed, along with varied reaction times. (See Table 6).

TABLE 6

| | PUR | MUF | | EE | | RXN |
|---|---|---|---|---|---|---|
| Sample ID | % | % | [M]/[U] | % | observations | Time |
| JB001-92 | 0.3 | 2 | 5 | 99.6 | Viable microcapsules | 4.5 h |
| JB001-101 | 0.4 | 5 | 3 | 99.0 | Viable microcapsules | 4.5 h |
| JB001-102 | 0.5 | 5 | 9 | 97 | Viable microcapsules | 4.5 h |
| JB001-103 | 0.75 | 4 | 5 | N/A | Clumped microcapsules | 4.5 h |
| | | | | | not viable | |
| JB001-104 | 0.5 | 4 | 5 | 99.4 | Viable microcapsules | 4.5 h |
| JB001-105 | 1 | 4 | 5 | N/A | Clumped microcapsules | 4.5 h |
| | | | | | not viable | |
| JB001-107 | 1 | 4 | 5 | N/A | Clumped microcapsules | 4.5 h |
| | | | | | not viable | |
| JB001-108 | 0.25 | 5 | 5 | 99.6 | Viable microcapsules | 5.5 h |

### Example 16

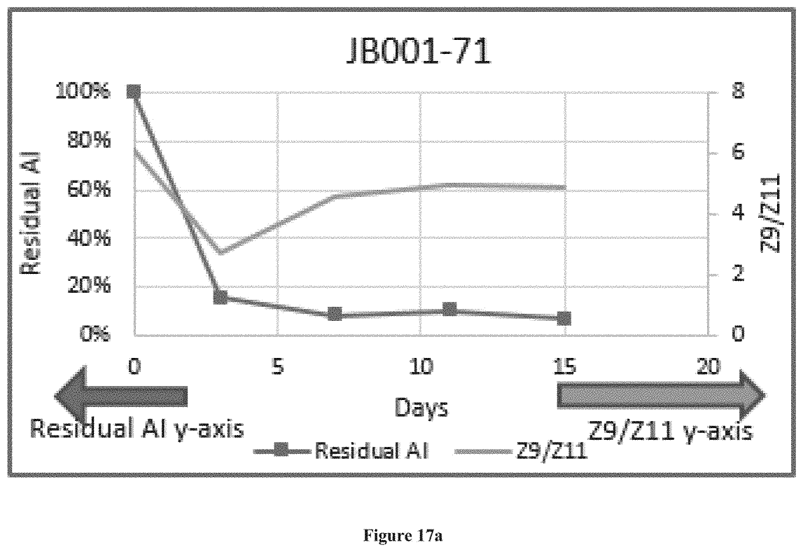

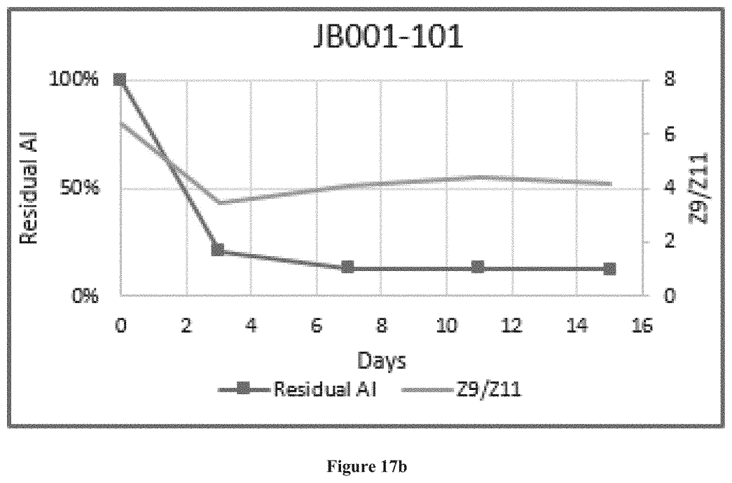

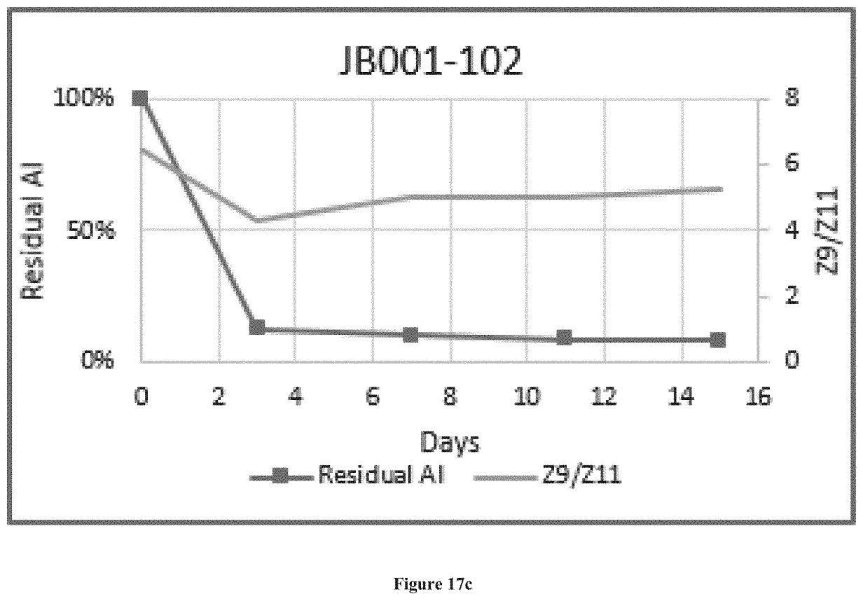

Initially synthesized thick wall (MUF 4-5%) capsules showed a 3-day release with residual AI analysis for microcapsules synthesized with 3.5-4.5 hours reaction time. (See FIGS. 17a-c and Table 7).

Increased reaction time of MUF 4% PUR-AR capsules to 4.5 hours resulted in a seven-day release and maintained Z9/Z11 ratio for the 15-day assay interval. (See FIG. 17a and Table 7). Increased reaction time for MUF 5% resulted in seven-day release followed by 60% lock-up. (See FIG. 17b and Table 7).

TABLE 7

| | PUR | Amino | | AR reaction |
|---|---|---|---|---|
| Sample ID | (wt %) | Resin (wt %) | M/U | time (hr) |
| JB001-71 (wave 1) | 0.5 | 4 | 5 | 3.5 |
| JB001-101 | 0.5 | 5 | 3 | 4.5 |
| JB001-102 | 0.5 | 5 | 9 | 4.5 |

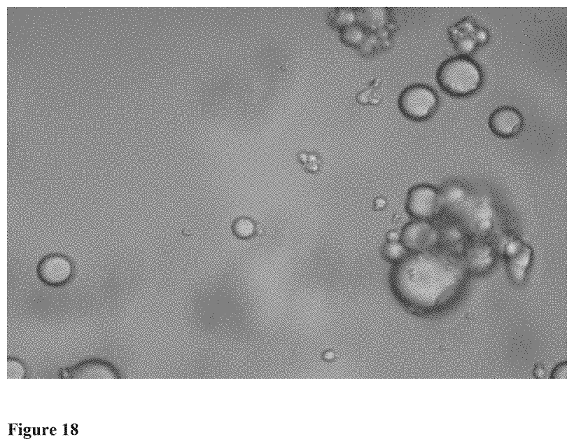

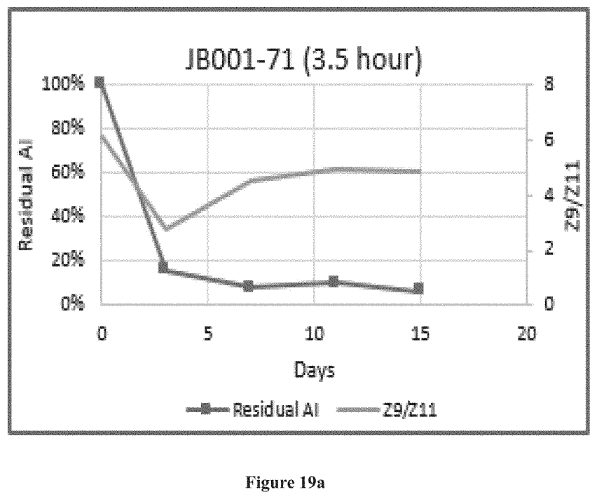

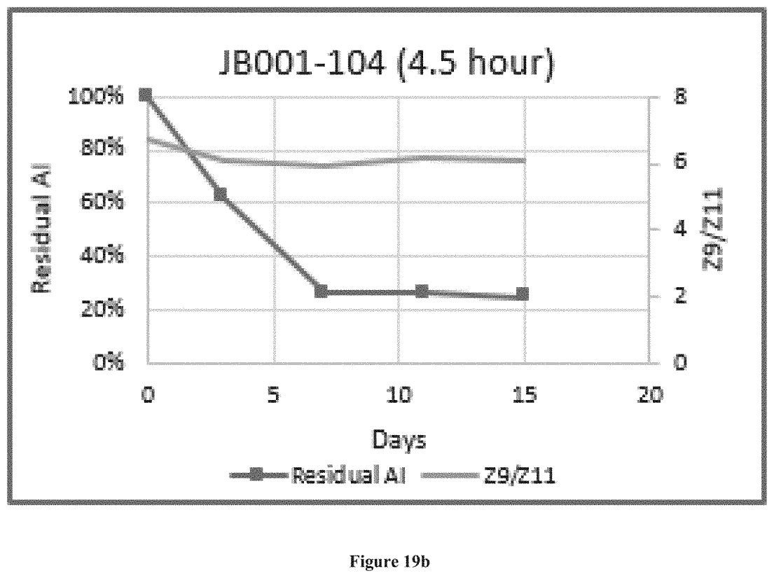

The tests show that microcapsules with a PUR percentage greater than 0.5% can result in clumped microcapsules formulations. (See FIG. 18). Variations in MUF wall thickness (MUF %) and M/U ratio were well tolerated. An increase in reaction time resulted in slower release of active ingredient. (See FIGS. 19a and 19b).

### Example 17

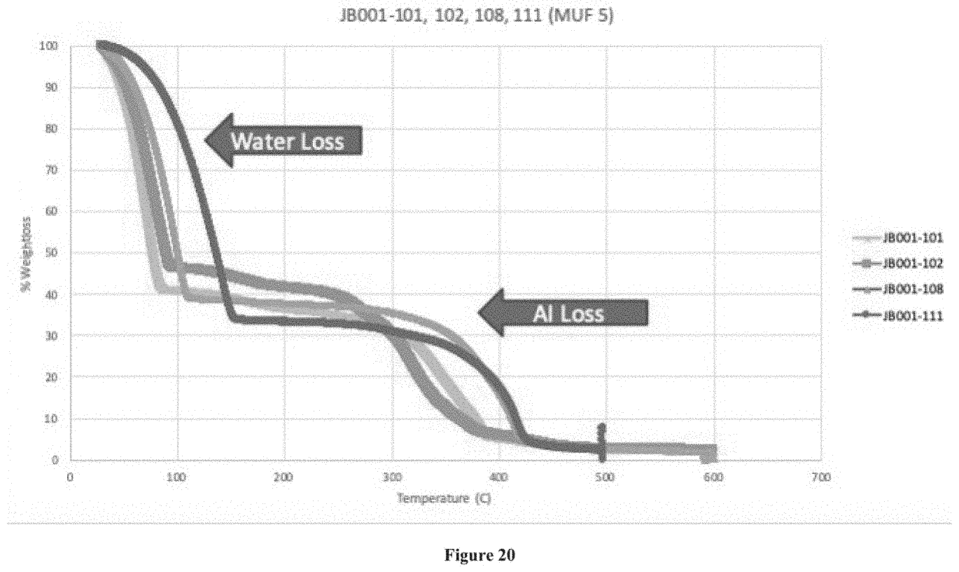

Thermogravimetric Analysis (TGA) was conducted on sample formulations. TGA is an analytical technique used to determine a material's thermal stability by monitoring the weight change that occurs as a sample is heated, which can evaluate microcapsule wall integrity and heat resistance by measuring the thermal stability of each formulation while heating. Formulations (20 μL) were placed in a platinum pan and heated at 20° C./min to 800° C. The change in mass due to the evaporation of formulation components was measured. As illustrated in FIG. 20, TGA analysis of MUF 5% formulations of PUR-MUF show that increased reaction time results in more stable capsules. Additionally, samples JB001-108 (5.5 h reaction time) and JB001-111 (8-hour reaction time) showed heat resistance until 360-365° C. and complete loss of AI at approx. 435° C. Sample JB001-102 was only thermally stable until 256° C., while JBOOl-101 was only thermally stable until 301 TC. Both formulations showed complete AI loss at approximately 380° C.

Microcapsules with increased reaction time (JB001-108 and 110) results in pheromones released and evaporated at much higher temp (365-425° C.) than those with 4.5 h reaction time (256-380° C.). Long reaction time capsules can withstand higher vapor pressures due to tighter wall structure, resulting in slower release of AI.

### Example 18

PUR-MUF capsules were synthesized with a fixed seven-hour reaction time. PUR percentage was fixed to 0.250 to ensure that interfacial polymerization reaction was completed prior to MUF addition. MUF percentage was varied from 2 to 90 to determine the effects of wall thickness on release. [M]/[U] ratio was varied to determine effects of capsule wall flexibility on release rate, as shown in Table 8.

TABLE 8

| | PUR | MUF | | EE | |
|---|---|---|---|---|---|
| Sample ID | % | % | [M]/[U] | % | observations |
| JB001-109 | 0.25 | 4 | 7 | 99.1 | Viable microcapsules |
| JB001-110 | 0.25 | 7 | 3 | 98.4 | Viable microcapsules |
| JB001-111 | 0.25 | 5 | 5 | 97.7 | Viable microcapsules |
| JB001-112 | 0.25 | 9 | 5 | 97.7 | Viable microcapsules |
| JB001-113 | 0.25 | 5 | 3 | 100 | Viable microcapsules |
| JB001-114 | 0.25 | 5 | 9 | 99.4 | Viable microcapsules |
| JB001-115 | 0.25 | 6 | 3 | 94.8 | Viable microcapsules |
| JB001-116 | 0.25 | 4 | 9 | 84.2 | Viable microcapsules |
| JB001-117 | 0.25 | 6 | 9 | 100 | Viable microcapsules |
| JB001-118 | 0.25 | 6 | 7 | 99.8 | Viable microcapsules |
| JB001-119 | 0.25 | 5 | 11 | 99.7 | Viable microcapsules |
| JB001-121 | 0.25 | 7 | 9 | 97.7 | Viable microcapsules |
| JB001-122 | 0.25 | 4 | 3 | 95.1 | Viable microcapsules |
| JB001-123 | 0.25 | 6 | 3 | 95.5 | Viable microcapsules |
| JB001-125 | 0.25 | 3 | 5 | 97.6 | Viable microcapsules |
| JB001-126 | 0.25 | 3 | 9 | 99.5 | Viable microcapsules |
| JB001-127 | 0.25 | 5 | 2 | 97.6 | Viable microcapsules |
| JB001-128 | 0.25 | 3 | 3 | 95.7 | Viable microcapsules |
| JB001-129 | 0.25 | 4 | 2 | TBA | Viable microcapsules |
| JB001-130 | 0.25 | 2 | 9 | TBA | Viable microcapsules |
| JB001-131 | 0.25 | 2 | 3 | TBA | Viable microcapsules |
| JB001-132 | 0.25 | 2 | 7 | TBA | Viable microcapsules |

### Example 19

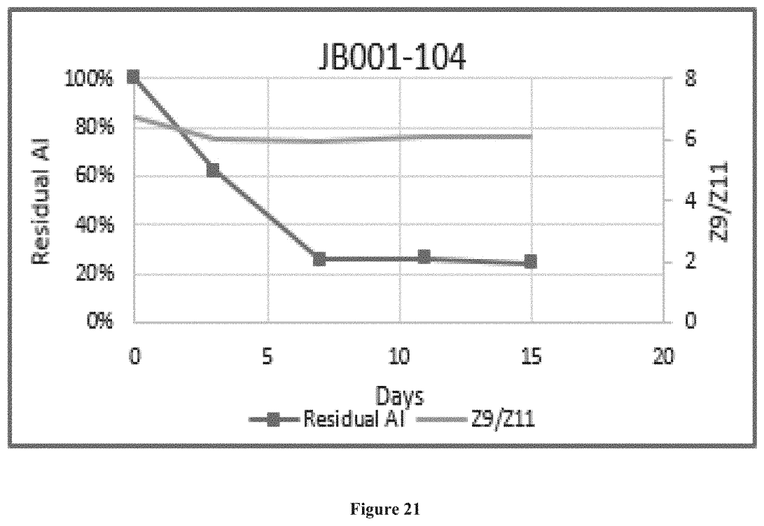

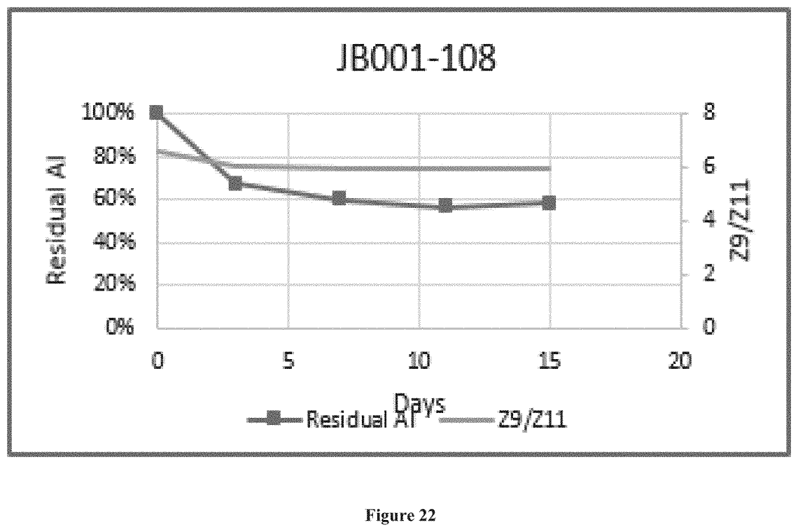

Sample JB001-104 (MUF4%, 4.5-hour reaction time) showed 7-day release (26% lock up) and maintained Z8/Z11 ratio (5.9) for the 15-day assay interval. JB001-108 (MUF 5%, 8-hour reaction time) resulted in seven-day release followed by 60% lock-up, as shown in FIGS. 21 and 22, and Table 9).

TABLE 9

| | PUR | Amino | | AR reaction |
|---|---|---|---|---|
| | (wt %) | Resin (wt %) | M/U | time (hr) |
| JB001-104 | 0.5 | 4 | 5 | 4.5 |
| JB001-108 | 0.25 | 5 | 5 | 5.5 |

### Example 18

To assess PUR and PUR-MUF sprayables for behavioral/biological efficacy and duration, live male FAW moths were presented with treated parchment papers to observe attraction response as indicator of pheromone release from formulation. The parchment papers were sprayed using an air brush (˜1.8 mg AI in ˜0.7 g formulation). The treated papers were placed in a wind tunnel that drew air towards moths @ 30 cm/s. Blank septa were included as controls and make the appearance of the apparatus the same for lure studies. Treatments were aged at 40 C, 50% RH.

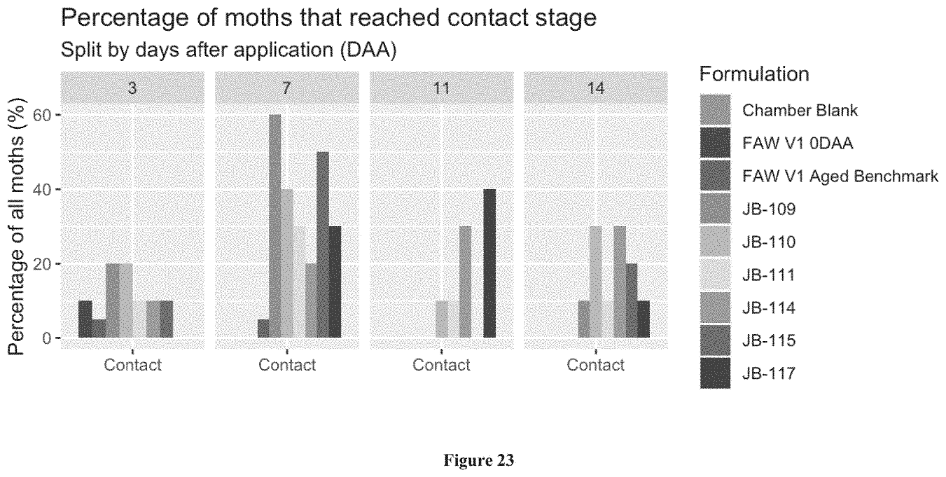

Samples included septa that was treated with PUR microcapsules (FAW V1 ODAA and FAW V1 Aged Benchmark) and PUR-MUF (JB-109 through JB-111 and JB-114 through JB-117). For PUR-MUF samples, Table 10 shows the [M]/[U] ratios that each JB sample contains. Behaviors were observed and recorded for 10 moths per aged treatment or control. As shown in FIG. 23, the results of percent of moths contacting the septa after 3, 7, 11, and 14 days after application. The PUR sample (FAW V1 Aged Benchmark) produced contact at 3 DAA and at 7 days after application. The PUR-MUF treatments were contacted at 3, 7, 11 and 14 days after application.

TABLE 10
Flight Tunnel

| | | M/U | | | | | |
|---|---|---|---|---|---|---|---|
| JB001- | | 2 | 3 | 5 | 7 | 9 | 11 |
| MUF | 2 | | 131 | | 132 | 130 | |
| | 3 | | 128 | 125 | | 126 | |
| | 4 | 129 | 122 | | 109 | 116 | |
| | 5 | 127 | 113 | 111 | | 114 | 119 |
| | 6 | | 115 | | 118 | 117 | |
| | 7 | | 110 | | | 121 | |
| | 9 | | | 112 | | | |

What may be claimed is:

1. A sprayable capsule pheromone formulation comprising:
an oil phase containing at least one sex pheromone;
a water phase containing a multiamine and at least one surfactant; and
at least one polyurea shell material formed by interfacial polymerization between diisocyanates in the oil phase and multiamine in the water phase.

2. The sprayable capsule formulation of claim 1, wherein the at least one pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

3. The sprayable capsule formulation of claim 2, wherein the mixture of (Z)-9-Tetradecenyl Acetate (Z9-14Ac) and (Z)-11-Hexadecenyl Acetate (Z11-16Ac) is present in a mass ratio of 87:13.

4. The sprayable capsule formulation of claim 1, wherein a median diameter of the capsule is in the rage of 3-20 microns.

5. The sprayable capsule formulation of claim 1, wherein the diisocyanates are selected from the group consisting of 2,4-toluene diisocyanate (TDI), 4,4-diphenylmethane diisocyanate (MDI), isophorone diisocyanate (IPDI), and 1,6-hexamethylene diisocyanate (HDI).

6. The sprayable capsule formulation of claim 1, wherein the oil phase includes a diluent oil consisting of paraffin oil, epoxidized soybean oil, wax, or a combination thereof.

7. The sprayable capsule formulation of claim 1, wherein the multiamine is selected from the group consisting of ethylenediamine (EDA), hexanediamine (HDA), diethylenetriamine (DETA), and urea.

8. The sprayable capsule formulation of claim 1, wherein the formulation comprises:
a pheromone content of 1-50 wt %; and
a microcapsule shell material content of 2-10 wt %;
wherein the median microcapsule diameter is 1-100 microns.

9. A method of forming a sprayable capsule pheromone formulation comprising:
providing an oil phase containing at least one sex pheromone and at least one diisocyanate;
providing a water phase containing a multiamine; and
emulsifying the oil phase in the aqueous phase with at least one emulsifier;
increasing the temperature of the emulsified oil; and
adding multiamines to the water phase to form a polyurea shell material between the oil phase and the water phase.

10. The method of claim 1, wherein the at least one pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

11. The method of claim 10, wherein the mixture of (Z)-9-Tetradecenyl Acetate (Z9-14Ac) and (Z)-11-Hexadecenyl Acetate (Z11-16Ac) is present in a mass ratio of 87:13.

12. The method of claim 1, wherein a median diameter of the capsule is in the range of 3-20 microns.

13. The method of claim 1, wherein the diisocyanates are selected from the group consisting of 2,4-toluene diisocyanate (TDI), 4,4-diphenylmethane diisocyanate (MDI), isophorone diisocyanate (IPDI), and 1,6-hexamethylene diisocyanate (HDI).

14. The method of claim 1, wherein the oil phase includes a diluent oil consisting of paraffin oil, epoxidized soybean oil, wax, or a combination thereof.

15. The method of claim 1, wherein the multiamine is selected from the group consisting of ethylenediamine (EDA), hexanediamine (HDA), diethylenetriamine (DETA), and urea.

16. A sprayable capsule pheromone formulation comprising:
an anionic oil phase emulsion containing at least one sex pheromone; and
a cationic melamine-urea-formaldehyde (MUF) polymer bonded to the anionic oil phase to form a melamine-urea-formaldehyde microcapsule on an exterior surface of the emulsion containing the at least or sex pheromone.

17. The sprayable capsule formulation of claim 16, wherein the anionic oil phase emulsion comprises sodium lignosulfonate.

18. The sprayable capsule formulation of claim 16, wherein the pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

19. The sprayable capsule formulation of claim 17, wherein the mixture of (Z)-9-Tetradecenyl Acetate (Z9-14Ac) and (Z)-11-Hexadecenyl Acetate (Z11-16Ac) is present in a mass ratio of 87:13; and the mixture of (Z)-11-Hexadecenal (Z11-16Ald) and (Z)-11-Hexadecenyl Acetate (Z11-16Ac) is present in a mass ratio of 50:50.

20. The sprayable capsule formulation of claim 1, wherein a median diameter of the capsule is in the range of 1-100 microns.

21. The sprayable capsule formulation of claim 1, wherein a median diameter of the capsule is in the range of 3-20 microns.

22. The sprayable capsule formulation of claim 1, wherein the formulation comprises:
a pheromone content of 1-50 wt %; and
a microcapsule shell material content of 2-10 wt %;
wherein the median microcapsule diameter is 1-100 microns.

23. A method of forming a sprayable capsule pheromone formulation comprising:
providing an aqueous formaldehyde solution;
adjusting the pH of the aqueous formaldehyde solution using a trisubstituted unreactive amine;
mixing the formaldehyde solution with solid melamine and urea to provide a water phase containing a multiamine;
heating the water phase to form a melamine-urea-formaldehyde (MUF) prepolymer;
emulsifying a pheromone in an aqueous solution containing an anioinic protective colloid to form pheromone emulsion droplets;
adding the MUF prepolymer solution to the aqueous solution to form a layer of MUF prepolymer ionically bonded to the pheromone emulsion droplets; and
heating the ionically bonded prepolymer to form a MUF microcapsule.

24. The method of claim 23, wherein the at least one pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

25. The method of claim 24, wherein the mixture of (Z)-9-Tetradecenyl Acetate (Z9-14Ac) and (Z)-11-Hexadecenyl Acetate (Z11-16Ac) is present in a mass ratio of 87:13; and the mixture of (Z)-11-Hexadecenal (Z11-16Ald) and (Z)-11-Hexadecenyl Acetate (Z11-16Ac) is present in a mass ratio of 50:50.

26. The method of claim 23, wherein a median diameter of the capsule is in the range of 1-100 microns.

27. The method of claim 23, wherein the anionic protective colloid comprises sodium lignosulfonate.

28. The degree of sulfonation of lignosulfonates of claim 17 is in the range of 0.5-3.3 moles/kg.

29. A sprayable capsule pheromone formulation comprising:
an oil phase emulsion containing at least one sex pheromone; and
a double layer shell made of a polyurea (PUR) layer and melamine-urea-formaldehyde (MUF) layer microcapsule encapsulating an exterior surface of the emulsion containing the at least one sex pheromone.

30. The sprayable capsule formulation of claim 29, wherein the pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

31. The sprayable capsule formulation of claim 30, wherein the mixture of (Z)-9-Tetradecenyl Acetate (Z9-14Ac) and (Z)-11-Hexadecenyl Acetate (Z11-16Ac) is present in a mass ratio of 87:13.

32. The sprayable capsule formulation of claim 29, wherein a median diameter of the capsule is in the range of 1-100 microns.

33. The sprayable capsule formulation of claim 29, wherein a median diameter of the capsule is in the range of 3-20 microns.

34. The sprayable capsule formulation of claim 29, wherein the PUR wt % is between 0.25% to 2% of the total weight of the formulation.

35. The sprayable capsule formulation of claim 29, wherein the MUF wt % is between 2% to 9% of the total weight of the formulation.

36. The sprayable capsule formulation of claim 29, wherein the ratio of melamine to urea in the formulation is from 9:1 to 2:1.

37. A method of forming a sprayable capsule pheromone formulation comprising:
providing an oil phase containing at least one sex pheromone and at least one diisocyanate;
providing a water phase containing a multiamine; and
emulsifying the oil phase in the aqueous phase with at least one emulsifier;
increasing the temperature of the emulsified oil;
adding multiamines to the water phase to form form a polyurea shell material between the oil phase and the water phase, wherein the polyurea shell material comprises an anionic emulsifier solution surrounding the polyurea shell material;
providing an aqueous formaldehyde solution;
adjusting the pH of the aqueous formaldehyde solution using a trisubstituted unreactive amine;
mixing the formaldehyde solution with solid melamine and urea to provide a water phase containing a multiamine;
heating the water phase to form a melamine-urea-formaldehyde (MUF) prepolymer;
adding the MUF prepolymer solution to the anionic emulsifier solution surrounding the PUR shell material to form a layer of MUF prepolymer ionically bonded to the PUR shell material; and
heating the ionically bonded prepolymer to form a polyurea and melamine-urea-formaldehyde (PUR-MUF) microcapsule.

38. The method of claim 37, wherein the at least one pheromone is selected from the group consisting of:
(Z)-7-Dodecen-1-yl Acetate (Z7-12Ac), (Z)-8-Dodecenyl acetate (Z8-12Ac), (Z)-9-Dodecenyl acetate (Z9-12Ac), (E,Z)-7,9-Dodecadienyl acetate (E7Z9-12Ac), (Z)-11-Tetradecenyl acetate (Z11-14Ac), (E)-5-Decenyl acetate (E5-10Ac), (E,E)-8,10-Decadienyl acetate (E8E10-10Ac), (Z)-11-Hexadecenyl acetate (Z11-16Ac), and mixtures thereof;
(Z)-9-Hexadecenal (Z9-16Ald), (Z)-11-Hexadecenal (Z11-16Ald), (Z)-13-Octadecenal (Z13-18Ald), (Z)-9-Octadecenal (Z9-18Ald), and mixtures thereof; and
(Z)-9-Tetradecenyl Acetate (Z9-14Ac), (Z)-11-Hexadecenyl Acetate (Z11-16Ac) and mixtures thereof.

39. The method of claim 38, wherein the mixture of (Z)-9-Tetradecenyl Acetate (Z9-14Ac) and (Z)-11-Hexadecenyl Acetate (Z11-16Ac) is present in a mass ratio of 87:13.

40. The method of claim 37, wherein a median diameter of the capsule is in the range of 3-20 microns.

41. The method of claim 37, wherein the diisocyanates are selected from the group consisting of 2,4-toluene diisocyanate (TDI), 4,4-diphenylmethane diisocyanate (MDI), isophorone diisocyanate (IPDI), and 1,6-hexamethylene diisocyanate (HDI).

42. The method of claim 37, wherein the oil phase includes a diluent oil consisting of paraffin oil, epoxidized soybean oil, wax, or a combination thereof.

43. The method of claim 37, wherein the multiamine is selected from the group consisting of ethylenediamine (EDA), hexanediamine (HDA), diethylenetriamine (DETA), and urea.

44. The method of claim 37, wherein the anionic protective colloid comprises sodium lignosulfonate.

45. The method of claim 37, wherein the amount of at least one diisocyanate used in the oil phase is between 0.25% to 2% of the total weight of the formulation.

46. The degree of sulfonation of lignosulfonates of claim 44 is in the range of 0.5-3.3 moles/kg.
